(19) United States
(12) Patent Application Publication
(10) Pub. No.: US 2024/0212889 A1
(43) Pub. Date: Jun. 27, 2024

(54) CHIP RESISTOR

(71) Applicant: ROHM CO., LTD., Kyoto-shi (JP)

(72) Inventor: Takanori SHINOURA, Kyoto-shi (JP)

(21) Appl. No.: 18/598,952

(22) Filed: Mar. 7, 2024

Related U.S. Application Data
(63) Continuation of application No. PCT/JP2022/033542, filed on Sep. 7, 2022.

(30) Foreign Application Priority Data
Oct. 29, 2021 (JP) 2021-177313
Nov. 2, 2021 (JP) 2021-179196

(51) Int. Cl. H01C 1/148; H01C 17/22

(52) U.S. Cl. CPC H01C 1/148; H01C 17/22

(57) ABSTRACT

A chip resistor includes an insulating substrate, a first electrode, a second electrode, a first resistive element, a second resistive element, and an intermediate electrode. A first length of the first resistive element in a first direction in which the first resistive element and the second resistive element are separated from each other is longer than a second length of the second resistive element in the first direction. The first resistive element is provided with a first trimming groove. The second resistive element is provided with a second trimming groove.

### TECHNICAL FIELD

The present disclosure relates to a chip resistor.

### BACKGROUND ART

Japanese Patent Laying-Open No. 2008-277638 (PTL 1) discloses a chip resistor including an insulating substrate, an upper surface electrode, a lower surface electrode, an end surface electrode, a single resistive element, an insulating protective film, and a front coating.

### CITATION LIST

### Patent Literature

PTL 1: Japanese Patent Laying-Open No. 2008-277638

### SUMMARY

In the chip resistor in PTL 1, the single resistive element is provided at the center of the insulating substrate and the entire resistive element is covered with the insulating protective film. Therefore, disadvantageously, a temperature at the center of the chip resistor excessively increases while the chip resistor is used, and short time overload (STOL) characteristics of the chip resistor are insufficient. The present disclosure was made in view of the problem, and an object thereof is to improve short time overload (STOL) characteristics of a chip resistor.

A chip resistor in the present disclosure includes an insulating substrate, a first electrode, a second electrode, a first resistive element, a second resistive element, and an intermediate electrode. The insulating substrate is provided with a first main surface, a first side surface, and a second side surface opposite to the first side surface. The first side surface and the second side surface are each connected to the first main surface. In a plan view of the first main surface, the first electrode is provided closer to the first side surface than the second electrode. The first electrode includes a first front electrode provided on the first main surface. The second electrode is separated from the first electrode and provided closer to the second side surface than the first electrode in the plan view of the first main surface. The second electrode includes a second front electrode provided on the first main surface, the second front electrode being separated from the first front electrode. The first resistive element is provided on the first main surface and in contact with the first front electrode and the intermediate electrode. The second resistive element is provided on the first main surface, separated from the first resistive element, and in contact with the second front electrode and the intermediate electrode. A first length of the first resistive element in a first direction in which the first resistive element and the second resistive element are separated from each other is longer than a second length of the second resistive element in the first direction. The intermediate electrode is provided on the first main surface and arranged between the first resistive element and the second resistive element. The first resistive element is provided with a first trimming groove. The second resistive element is provided with a second trimming groove.

### BRIEF DESCRIPTION OF DRAWINGS

FIG. 1 is a schematic plan view of a chip resistor in a first embodiment.

FIG. 2 is a schematic cross-sectional view of the chip resistor in the first embodiment along the line II-II shown in FIG. 1.

FIG. 3 is a schematic cross-sectional view of the chip resistor in the first embodiment mounted on a wiring board.

FIG. 4 is a schematic cross-sectional view showing one step in a method of manufacturing the chip resistor in the first embodiment.

FIG. 5 is a schematic cross-sectional view showing a step next to the step shown in FIG. 4, in the method of manufacturing the chip resistor in the first embodiment.

FIG. 6 is a schematic cross-sectional view showing a step next to the step shown in FIG. 5, in the method of manufacturing the chip resistor in the first embodiment.

FIG. 7 is a schematic cross-sectional view showing a step next to the step shown in FIG. 6, in the method of manufacturing the chip resistor in the first embodiment.

FIG. 8 is a schematic cross-sectional view showing a step next to the step shown in FIG. 7, in the method of manufacturing the chip resistor in the first embodiment.

FIG. 9 is a diagram showing a graph of relation between a rate of change in resistance value of the chip resistor due to trimming of a resistive element and a ratio of a trimming groove absent portion in a width direction of the resistive element, of the chip resistor in the first embodiment and the chip resistor in a second comparative example.

FIG. 10 is a schematic plan view of the chip resistor in a modification of the first embodiment.

FIG. 11 is a schematic cross-sectional view of the chip resistor in the modification of the first embodiment along the line XI-XI shown in FIG. 10.

FIG. 12 is a schematic plan view of the chip resistor in a second embodiment.

FIG. 13 is a schematic cross-sectional view of the chip resistor in the second embodiment along the line XIII-XIII shown in FIG. 12.

FIG. 14 is a schematic cross-sectional view of the chip resistor in the second embodiment mounted on the wiring board.

FIG. 15 is a schematic cross-sectional view showing one step in a method of manufacturing the chip resistor in the second embodiment.

FIG. 16 is a schematic cross-sectional view showing a step next to the step shown in FIG. 15, in the method of manufacturing the chip resistor in the second embodiment.

FIG. 17 is a schematic cross-sectional view showing a step next to the step shown in FIG. 16, in the method of manufacturing the chip resistor in the second embodiment.

FIG. 18 is a schematic cross-sectional view showing a step next to the step shown in FIG. 17, in the method of manufacturing the chip resistor in the second embodiment.

FIG. 19 is a schematic cross-sectional view showing a step next to the step shown in FIG. 18, in the method of manufacturing the chip resistor in the second embodiment.

FIG. 20 is a schematic plan view of the chip resistor in a first modification of the second embodiment.

FIG. 21 is a schematic cross-sectional view of the chip resistor in the first modification of the second embodiment along the line XXI-XXI shown in FIG. 20.

FIG. 22 is a schematic plan view of the chip resistor in a second modification of the second embodiment.

FIG. 23 is a schematic cross-sectional view of the chip resistor in the second modification of the second embodiment along the line XXIII-XXIII shown in FIG. 22.

### DETAILED DESCRIPTION

Details of an embodiment of the present disclosure will now be described with reference to the drawings. The same or corresponding elements in the drawings below have the same reference characters allotted and description thereof will not be repeated. Features in at least a part of the embodiment which will be described below may freely be combined.

### First Embodiment

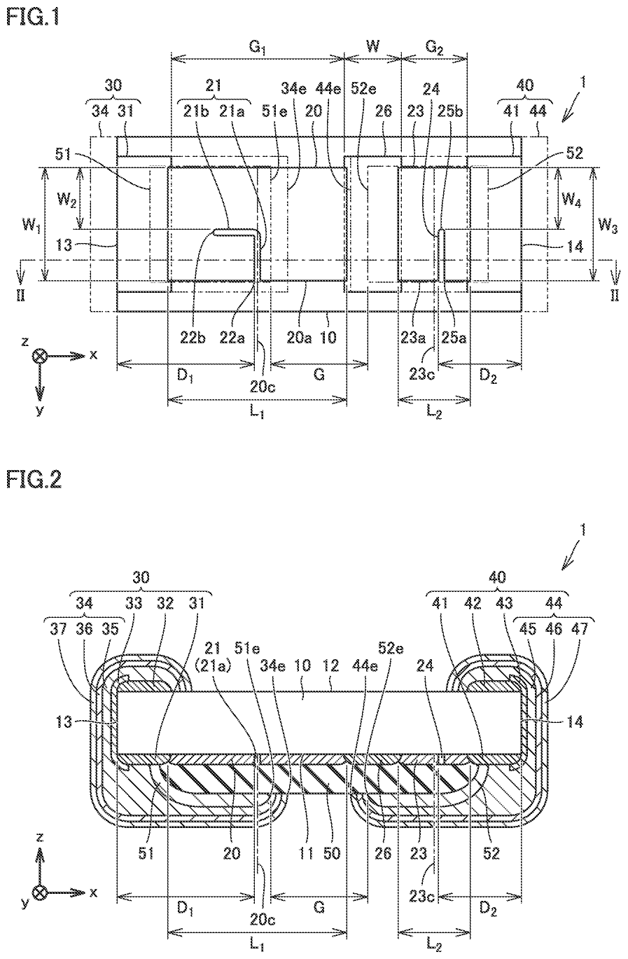

A chip resistor 1 in a first embodiment will be described with reference to FIGS. 1 and 2. Chip resistor 1 includes an insulating substrate 10, a first electrode 30, a second electrode 40, a first resistive element 20, a second resistive element 23, and an intermediate electrode 26. Chip resistor 1 may further include a first electroconductive resin layer 51, a second electroconductive resin layer 52, and an insulating protective layer 50. FIG. 1 does not show insulating protective layer 50 for the sake of convenience.

Insulating substrate 10 is formed of an electrically insulating material such as alumina (Al₂O₃). Insulating substrate 10 is provided with a first main surface 11, a second main surface 12 opposite to first main surface 11, a first side surface 13, and a second side surface 14 opposite to first side surface 13. First side surface 13 and second side surface 14 are each connected to first main surface 11 and second main surface 12. First main surface 11 and second main surface 12 each extend along a first direction (an x direction) and a second direction (a y direction) perpendicular to the first direction. The first direction (x direction) is, for example, a longitudinal direction of insulating substrate 10. The first direction (x direction) is a direction in which first side surface 13 and second side surface 14 are separated from each other. The first direction (x direction) is a direction in which first resistive element 20 and second resistive element 23 are separated from each other. The first direction (x direction) is a direction in which first electrode 30 and second electrode 40 are separated from each other. The second direction (y direction) is, for example, a direction of a short side of insulating substrate 10. First main surface 11 and second main surface 12 are separated from each other in a third direction (a z direction) perpendicular to the first direction (x direction) and the second direction (y direction). The third direction (z direction) is a direction of thickness of insulating substrate 10.

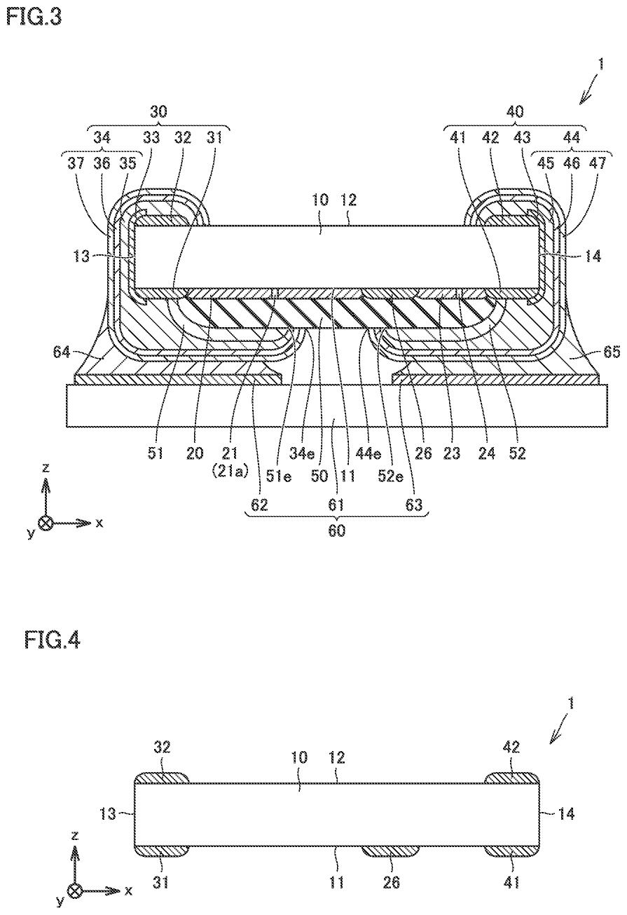

Referring to FIG. 3, in mount of chip resistor 1 on a wiring board 60, first main surface 11 faces wiring board 60. In other words, first main surface 11 is a mount surface used in mount of chip resistor 1 on wiring board 60. First main surface 11 is a carrying surface on which first resistive element 20 and second resistive element 23 are carried.

First resistive element 20 and second resistive element 23 perform a function to restrict a current or a function to detect a current. First resistive element 20 and second resistive element 23 are provided on first main surface 11 of insulating substrate 10. First resistive element 20 and second resistive element 23 are formed, for example, by printing a paste obtained by incorporating glass frit in an electrically resistive material such as ruthenium oxide (RuO₂) or a silver-palladium alloy onto first main surface 11 of insulating substrate 10 and firing the paste. Each of first resistive element 20 and second resistive element 23 is, for example, in a rectangular shape in a plan view of first main surface 11 of insulating substrate 10. First resistive element 20 and second resistive element 23 are aligned in the first direction (the x direction, for example, in the longitudinal direction of insulating substrate 10).

First resistive element 20 is provided on a side of first side surface 13 of insulating substrate 10. First resistive element 20 is provided closer to first side surface 13 than second resistive element 23. First resistive element 20 is in contact with a first front electrode 31 and intermediate electrode 26.

First resistive element 20 is provided with a first trimming groove 21. Provision of first trimming groove 21 in first resistive element 20 allows accurate determination of a resistance value of chip resistor 1 (first resistive element 20). First trimming groove 21 includes an end 22a and an end 22b opposite to end 22a. End 22a is located in an outer periphery 20a of first resistive element 20. Outer periphery 20a extends along the first direction (x direction). In the first direction (x direction), a position of end 22b is displaced from a position of end 22a. In the present embodiment, in the first direction (x direction), end 22b is closer to first front electrode 31 than end 22a, and end 22a is closer to intermediate electrode 26 than end 22b. In the plan view of first main surface 11 of insulating substrate 10, first trimming groove 21 is, for example, in an L shape.

First trimming groove 21 includes a trimming groove portion 21a and a trimming groove portion 21b. A longitudinal direction of trimming groove portion 21a extends along the direction (second direction (y direction)) perpendicular to the first direction (x direction). Trimming groove portion 21a includes end 22a. Trimming groove portion 21a is provided on a first centerline 20c of first resistive element 20 in the first direction (x direction) or close to first front electrode 31 with respect to first centerline 20c. A position of trimming groove portion 21a with respect to first centerline 20c of first resistive element 20 is defined by a centerline of trimming groove portion 21a with respect to first centerline 20c of first resistive element 20. In other words, trimming groove portion 21a being provided on first centerline 20c of first resistive element 20 means that the centerline of trimming groove portion 21a coincides with first centerline 20c of first resistive element 20. Trimming groove portion 21a being provided close to first front electrode 31 with respect to first centerline 20c of first resistive element 20 means that the centerline of trimming groove portion 21a is closer to first front electrode 31 than first centerline 20c of first resistive element 20.

The longitudinal direction of trimming groove portion 21b extends along the first direction (x direction). Trimming groove portion 21b includes end 22b. Trimming groove portion 21b is connected to an end of trimming groove portion 21a opposite to end 22a. In the plan view of first main surface 11 of insulating substrate 10, trimming groove portion 21b extends from trimming groove portion 21a toward first front electrode 31. In the first direction (x direction), trimming groove portion 21b is provided close to first front electrode 31 with respect to trimming groove portion 21a. In the first direction (x direction), trimming groove portion 21a is provided closer to first centerline 20c of first resistive element 20 than trimming groove portion 21b.

Since first resistive element 20 is in contact with first front electrode 31, a material that forms first front electrode 31 is diffused in a part of first resistive element 20. From first centerline 20c of first resistive element 20 toward first front electrode 31, more material that forms first front electrode 31 is diffused in first resistive element 20. From first centerline 20c of first resistive element 20 toward first front electrode 31, an electric resistivity of first resistive element 20 gently lowers. Therefore, by forming trimming groove portion 21a and then forming trimming groove portion 21b from trimming groove portion 21a toward first front electrode 31, a rate of change in electric resistivity of first resistive element 20 per unit length of trimming groove portion 21b is lower. The electric resistivity of first resistive element 20 can more accurately be set. The electric resistivity of chip resistor 1 can more accurately be set.

Second resistive element 23 is separated from first resistive element 20. Second resistive element 23 is provided on a side of second side surface 14 of insulating substrate 10. Second resistive element 23 is provided closer to second side surface 14 than first resistive element 20. Second resistive element 23 is in contact with a second front electrode 41 and intermediate electrode 26.

A second trimming groove 24 is provided in second resistive element 23. Provision of second trimming groove 24 in second resistive element 23 allows accurate determination of the resistance value of chip resistor 1 (second resistive element 23). Second trimming groove 24 includes an end 25a and an end 25b opposite to end 25a. End 25a is located in an outer periphery 23a of second resistive element 23. Outer periphery 23a extends along the first direction (x direction). A longitudinal direction of second trimming groove 24 extends along the second direction (y direction) perpendicular to the first direction (x direction). A position of end 25b in the first direction (x direction) is the same as the position of end 25a in the first direction (x direction). In the plan view of first main surface 11 of insulating substrate 10, second trimming groove 24 is, for example, in a linear shape extending in the second direction (y direction).

In the plan view of first main surface 11 of insulating substrate 10, second trimming groove 24 is provided close to second front electrode 41 and second side surface 14 with respect to a second centerline 23c of second resistive element 23 in the first direction (x direction). In the plan view of first main surface 11 of insulating substrate 10, a second distance D₂ between second trimming groove 24 and second side surface 14 is, for example, 400 μm or shorter. Second distance D₂ is a shortest distance between second trimming groove 24 and second side surface 14 in the plan view of first main surface 11 of insulating substrate 10. Second distance D₂ may be 300 μm or shorter.

A first length L₁ of first resistive element 20 in the first direction (x direction) is longer than a second length L₂ of second resistive element 23 in the first direction (x direction). First length L₁ of first resistive element 20 is at least 1.2 time as long as second length L₂ of second resistive element 23. First length L₁ of first resistive element 20 may be at least 1.5 time or at least 2.0 times as long as second length L₂ of second resistive element 23. Second length L₂ of second resistive element 23 may be at least one tenth of first length L₁ of first resistive element 20. Therefore, second trimming groove 24 can readily be provided in second resistive element 23.

A first ratio W₂/W₁ of a trimming groove absent portion in a width direction (the second direction (y direction)) of first resistive element 20 may substantially be equal to a second ratio W₄/W₃ of a trimming groove absent portion in the width direction (second direction (y direction)) of second resistive element 23. First ratio W₂/W₁ of the trimming groove absent portion in first resistive element 20 being substantially equal to second ratio W₄/W₃ of the trimming groove absent portion in second resistive element 23 means that first ratio W₂/W₁ of the trimming groove absent portion in first resistive element 20 is not lower than 90% and not higher than 110% of second ratio W₄/W₃ of the trimming groove absent portion in second resistive element 23. First ratio W₂/W₁ of the trimming groove absent portion in first resistive element 20 may be not lower than 95% and not higher than 105% of second ratio W₄/W₃ of the trimming groove absent portion in second resistive element 23. First ratio W₂/W₁ of the trimming groove absent portion in first resistive element 20 may be equal to second ratio W₄/W₃ of the trimming groove absent portion in second resistive element 23.

First ratio W₂/W₁ of the trimming groove absent portion in the width direction (the second direction (y direction)) of first resistive element 20 means a ratio of a portion of first resistive element 20 where first trimming groove 21 is not provided in the width direction of first resistive element 20. W₁ represents the entire width of first resistive element 20 and a length of first resistive element 20 in the second direction (y direction) perpendicular to the first direction (x direction) in the plan view of first main surface 11 of insulating substrate 10. W₂ represents a length of the portion of first resistive element 20 where first trimming groove 21 is not provided in the second direction (y direction) perpendicular to the first direction (x direction) in the plan view of first main surface 11 of insulating substrate 10.

Second ratio W₄/W₃ of the trimming groove absent portion in the width direction (second direction (y direction)) of second resistive element 23 means a ratio of a portion of second resistive element 23 where second trimming groove 24 is not provided in the width direction of second resistive element 23. W₃ represents the entire width of second resistive element 23 and a length of second resistive element 23 in the second direction (y direction) perpendicular to the first direction (x direction) in the plan view of first main surface 11 of insulating substrate 10. W₄ represents a length of the portion of second resistive element 23 where second trimming groove 24 is not provided in the second direction (y direction) perpendicular to the first direction (x direction) in the plan view of first main surface 11 of insulating substrate 10.

Intermediate electrode 26 is provided on first main surface 11 of insulating substrate 10. Intermediate electrode 26 is arranged between first resistive element 20 and second resistive element 23. Intermediate electrode 26 is in contact with first resistive element 20 and second resistive element 23 to electrically connect first resistive element 20 and second resistive element 23 to each other in series. Intermediate electrode 26 is separated from first front electrode 31 and second front electrode 41. First front electrode 31, intermediate electrode 26, and second front electrode 41 are aligned in the first direction (x direction). Intermediate electrode 26 is arranged closer to second front electrode 41 than first front electrode 31 in a direction of alignment (the first direction (x direction)) of first front electrode 31, intermediate electrode 26, and second front electrode 41. Intermediate electrode 26 is arranged closer to second side surface 14 than first side surface 13 in the direction of alignment (the first direction (x direction)) of first front electrode 31, intermediate electrode 26, and second front electrode 41.

In the plan view of first main surface 11, intermediate electrode 26 may be superimposed on first resistive element 20 over a width of 100 μm or larger in the first direction (x direction). Therefore, even in consideration of a manufacturing error, intermediate electrode 26 can more reliably be in contact with first resistive element 20. In the plan view of first main surface 11, intermediate electrode 26 may be superimposed on second resistive element 23 over a width of 100 μm or larger in the first direction (x direction). Therefore, even in consideration of a manufacturing error, intermediate electrode 26 can more reliably be in contact with second resistive element 23. Intermediate electrode 26 may have a width W in the first direction (x direction) equal to or larger than 300 μm. Therefore, contact between intermediate electrode 26 and first resistive element 20 and contact between intermediate electrode 26 and second resistive element 23 can be ensured and contact between first resistive element 20 and second resistive element 23 can more reliably be prevented.

Width W of intermediate electrode 26 may be determined such that an interval G₁ between first front electrode 31 and intermediate electrode 26 in the first direction (x direction) is larger than an interval G₂ between second front electrode 41 and intermediate electrode 26 in the first direction (x direction) and interval G₂ between second front electrode 41 and intermediate electrode 26 in the first direction (x direction) is 300 μm or larger. Therefore, even in consideration of a diameter of laser beams and accuracy in position of laser beams used for providing first trimming groove 21 and second trimming groove 24, provision of first trimming groove 21 in first resistive element 20 and second trimming groove 24 in second resistive element 23 can be ensured, and trimming of first front electrode 31, second front electrode 41, and intermediate electrode 26 by laser beams can more reliably be prevented.

Intermediate electrode 26 is formed, for example, by printing a conductive paste such as a paste obtained by incorporating glass frit in silver onto first main surface 11 of insulating substrate 10 and firing the conductive paste.

Insulating protective layer 50 is provided on first resistive element 20, second resistive element 23, and intermediate electrode 26. Insulating protective layer 50 may further be provided on first front electrode 31 and second front electrode 41.

Insulating protective layer 50 electrically isolates first electrode 30 and second electrode 40 from each other. Insulating protective layer 50 electrically isolates a first metallic plated layer 34 and a second metallic plated layer 44 from each other. Insulating protective layer 50 electrically isolates first electroconductive resin layer 51 and second electroconductive resin layer 52 from each other. Insulating protective layer 50 is formed of an insulating resin such as an epoxy resin. Insulating protective layer 50 is formed, for example, by printing and curing a paste containing the insulating resin.

First electroconductive resin layer 51 is provided on first front electrode 31 and insulating protective layer 50. First electroconductive resin layer 51 covers at least a part of first resistive element 20 in the plan view of first main surface 11 of insulating substrate 10. In the plan view of first main surface 11 of insulating substrate 10, first electroconductive resin layer 51 covers, for example, at least 20% of an area of first resistive element 20. In the plan view of first main surface 11 of insulating substrate 10, first electroconductive resin layer 51 may cover at least 30% of the area of first resistive element 20, at least 40% of the area of first resistive element 20, at least 50% of the area of first resistive element 20, at least 60% of the area of first resistive element 20, at least 70% of the area of first resistive element 20, at least 80% of the area of first resistive element 20, at least 90% of the area of first resistive element 20, or the entirety of first resistive element 20.

In the plan view of first main surface 11 of insulating substrate 10, first electroconductive resin layer 51 may have an end 51e closer to second side surface 14 and second front electrode 41 than first centerline 20c of first resistive element 20 in the first direction (x direction). In the plan view of first main surface 11 of insulating substrate 10, end 51e of first electroconductive resin layer 51 is a distal end of first electroconductive resin layer 51 from first side surface 13. In the plan view of first main surface 11 of insulating substrate 10, end 51e of first electroconductive resin layer 51 is a proximal end of first electroconductive resin layer 51 to intermediate electrode 26.

In the plan view of first main surface 11 of insulating substrate 10, first electroconductive resin layer 51 covers at least a part of first trimming groove 21. In the plan view of first main surface 11 of insulating substrate 10, first electroconductive resin layer 51 covers, for example, at least 50% of the entire length of first trimming groove 21. In the plan view of first main surface 11 of insulating substrate 10, first electroconductive resin layer 51 may cover the entirety of trimming groove portion 21a. In the plan view of first main surface 11 of insulating substrate 10, first electroconductive resin layer 51 may cover the entirety of first trimming groove 21.

First electroconductive resin layer 51 contains a binder resin and electroconductive particles added to the binder resin. The binder resin is formed of an epoxy resin, a phenol resin, or combination thereof. The electroconductive particles are lower in electric resistivity than the binder resin. The electroconductive particles are, for example, metallic particles such as silver particles or copper particles, carbon particles, or combination thereof. First electroconductive resin layer 51 is formed, for example, by printing and curing a paste containing the binder resin and the electroconductive particles. The electroconductive particles are higher in thermal conductivity than the binder resin. First electroconductive resin layer 51 is higher in thermal conductivity than insulating protective layer 50.

Second electroconductive resin layer 52 is provided on second front electrode 41 and insulating protective layer 50. In the plan view of first main surface 11 of insulating substrate 10, second electroconductive resin layer 52 covers at least a part of second resistive element 23. In the plan view of first main surface 11 of insulating substrate 10, second electroconductive resin layer 52 covers, for example, at least 20% of an area of second resistive element 23. In the plan view of first main surface 11 of insulating substrate 10, second electroconductive resin layer 52 may cover at least 30% of the area of second resistive element 23, at least 40% of the area of second resistive element 23, at least 50% of the area of second resistive element 23, at least 60% of the area of second resistive element 23, at least 70% of the area of second resistive element 23, at least 80% of the area of second resistive element 23, at least 90% of the area of second resistive element 23, or the entirety of second resistive element 23.

In the plan view of first main surface 11 of insulating substrate 10, second electroconductive resin layer 52 may have an end 52e closer to first side surface 13 and first front electrode 31 than second centerline 23c of second resistive element 23 in the first direction (x direction). In the plan view of first main surface 11 of insulating substrate 10, end 52e of second electroconductive resin layer 52 is a distal end of second electroconductive resin layer 52 from second side surface 14. In the plan view of first main surface 11 of insulating substrate 10, end 52e of second electroconductive resin layer 52 is a proximal end of second electroconductive resin layer 52 to intermediate electrode 26.

In the plan view of first main surface 11 of insulating substrate 10, second electroconductive resin layer 52 covers at least a part of second trimming groove 24. In the plan view of first main surface 11 of insulating substrate 10, second electroconductive resin layer 52 covers, for example, at least 50% of the entire length of second trimming groove 24. In the plan view of first main surface 11 of insulating substrate 10, second electroconductive resin layer 52 may cover the entirety of second trimming groove 24.

Second electroconductive resin layer 52 contains a binder resin and electroconductive particles added to the binder resin. The binder resin is formed of an epoxy resin, a phenol resin, or combination thereof. The electroconductive particles are lower in electric resistivity than the binder resin. The electroconductive particles are, for example, metallic particles such as silver particles or copper particles, carbon particles, or combination thereof. Second electroconductive resin layer 52 is formed, for example, by printing and curing a paste containing the binder resin and the electroconductive particles. The electroconductive particles are higher in thermal conductivity than the binder resin. Second electroconductive resin layer 52 is higher in thermal conductivity than insulating protective layer 50.

Second electroconductive resin layer 52 is separated from first electroconductive resin layer 51. An interval between first electroconductive resin layer 51 and second electroconductive resin layer 52 is, for example, 300 μm or larger. Therefore, contact between first electroconductive resin layer 51 and second electroconductive resin layer 52 and resultant electrical short-circuiting between first electroconductive resin layer 51 and second electroconductive resin layer 52 in formation of first electroconductive resin layer 51 and second electroconductive resin layer 52 can more reliably be prevented.

First electrode 30 is provided on the side of first side surface 13 of insulating substrate 10. In the plan view of first main surface 11 of insulating substrate 10, first electrode 30 is provided closer to first side surface 13 than second electrode 40. First electrode 30 includes first front electrode 31. First electrode 30 may further include a first back electrode 32, a first side surface electrode 33, and first metallic plated layer 34.

First front electrode 31 is provided on first main surface 11 of insulating substrate 10. First front electrode 31 is proximal to first side surface 13 relative to first resistive element 20. First front electrode 31 is in contact with first resistive element 20. In the plan view of first main surface 11 of insulating substrate 10, first front electrode 31 may extend to a ridgeline defined by first main surface 11 and first side surface 13. First front electrode 31 is formed, for example, by printing a paste containing silver onto first main surface 11 of insulating substrate 10 and firing the paste.

First back electrode 32 is provided on second main surface 12 of insulating substrate 10. In the plan view of first main surface 11 of insulating substrate 10, first back electrode 32 is superimposed on first front electrode 31. First back electrode 32 is formed, for example, by printing a paste containing silver onto second main surface 12 of insulating substrate 10 and firing the paste.

First side surface electrode 33 is provided on first side surface 13 of insulating substrate 10, first front electrode 31, and first back electrode 32. First side surface electrode 33 covers first side surface 13 of insulating substrate 10, first front electrode 31, and first back electrode 32. First side surface electrode 33 includes a first portion formed on first side surface 13 of insulating substrate 10, a second portion superimposed on first main surface 11 of insulating substrate 10 in the plan view in the direction of thickness (z direction) of insulating substrate 10, and a third portion superimposed on second main surface 12 of insulating substrate 10 in the plan view in the direction of thickness (z direction) of insulating substrate 10. First side surface electrode 33 electrically conducts to first front electrode 31 and first back electrode 32. First resistive element 20 electrically conducts to first back electrode 32 through first front electrode 31 and first side surface electrode 33. First side surface electrode 33 may be formed of a conductive material less likely to be sulfurized. First side surface electrode 33 is formed, for example, of an Ni—Cr alloy.

First metallic plated layer 34 is provided on first front electrode 31, first back electrode 32, first side surface electrode 33, and first electroconductive resin layer 51. First metallic plated layer 34 is in contact with first front electrode 31, first back electrode 32, first side surface electrode 33, and first electroconductive resin layer 51. First metallic plated layer 34 is higher in thermal conductivity than insulating protective layer 50.

In the plan view of first main surface 11 of insulating substrate 10, first metallic plated layer 34 has an end 34e closer to second front electrode 41 than first centerline 20c of first resistive element 20 in the first direction (x direction). In the plan view of first main surface 11 of insulating substrate 10, end 34e of first metallic plated layer 34 is a proximal end of first metallic plated layer 34 to intermediate electrode 26. In the plan view of first main surface 11 of insulating substrate 10, end 34e of first metallic plated layer 34 is a distal end of first metallic plated layer 34 from first side surface 13 of insulating substrate 10. First metallic plated layer 34 includes, for example, a first inner plated layer 35, a first intermediate plated layer 36, and a first outer plated layer 37.

First inner plated layer 35 is formed on first front electrode 31, first back electrode 32, first side surface electrode 33, and first electroconductive resin layer 51. First inner plated layer 35 is in contact with first front electrode 31, first back electrode 32, first side surface electrode 33, and first electroconductive resin layer 51. First inner plated layer 35 is, for example, a copper plated layer.

First intermediate plated layer 36 is formed on first inner plated layer 35 to cover first inner plated layer 35. First intermediate plated layer 36 protects first front electrode 31, first back electrode 32, first side surface electrode 33, and first inner plated layer 35 against heat and impact. First intermediate plated layer 36 is, for example, a nickel plated layer.

First outer plated layer 37 is formed on first intermediate plated layer 36 to cover first intermediate plated layer 36. First outer plated layer 37 is formed of a material to which a conductive bonding member 64 (see FIG. 3) such as solder is more readily attached than to first intermediate plated layer 36. First outer plated layer 37 is, for example, a tin plated layer. Conductive bonding member 64 is attached to first outer plated layer 37 and an electrical wire 62 of wiring board 60 (see FIG. 3), so that chip resistor 1 is mounted on wiring board 60.

Second electrode 40 is separated from first electrode 30. Second electrode 40 is provided on a side of second side surface 14 of insulating substrate 10. In the plan view of first main surface 11 of insulating substrate 10, second electrode 40 is provided closer to second side surface 14 than first electrode 30. Second electrode 40 includes second front electrode 41. Second electrode 40 may further include a second back electrode 42, a second side surface electrode 43, and second metallic plated layer 44.

Second front electrode 41 is provided on first main surface 11 of insulating substrate 10. Second front electrode 41 is separated from first front electrode 31. Second front electrode 41 is proximal to second side surface 14 relative to second resistive element 23. Second front electrode 41 is in contact with second resistive element 23. In the plan view of first main surface 11 of insulating substrate 10, second front electrode 41 may extend to a ridgeline defined by first main surface 11 and second side surface 14. Second front electrode 41 is formed, for example, by printing a paste containing silver onto first main surface 11 of insulating substrate 10 and firing the paste.

Second back electrode 42 is provided on second main surface 12 of insulating substrate 10. In the plan view of first main surface 11 of insulating substrate 10, second back electrode 42 is superimposed on second front electrode 41. Second back electrode 42 is formed, for example, by printing a paste containing silver onto second main surface 12 of insulating substrate 10 and firing the paste.

Second side surface electrode 43 is provided on second side surface 14 of insulating substrate 10, second front electrode 41, and second back electrode 42. Second side surface electrode 43 covers second side surface 14 of insulating substrate 10, second front electrode 41, and second back electrode 42. Second side surface electrode 43 includes a first portion formed on second side surface 14 of insulating substrate 10, a second portion superimposed on first main surface 11 of insulating substrate 10 in the plan view in the direction of thickness (z direction) of insulating substrate 10, and a third portion superimposed on second main surface 12 of insulating substrate 10 in the plan view in the direction of thickness (z direction) of insulating substrate 10. Second side surface electrode 43 electrically conducts to second front electrode 41 and second back electrode 42. Second resistive element 23 electrically conducts to second back electrode 42 through second front electrode 41 and second side surface electrode 43. Second side surface electrode 43 may be formed of a conductive material less likely to be sulfurized. Second side surface electrode 43 is formed, for example, of an Ni—Cr alloy.

Second metallic plated layer 44 is provided on second front electrode 41, second back electrode 42, second side surface electrode 43, and second electroconductive resin layer 52. Second metallic plated layer 44 is in contact with second front electrode 41, second back electrode 42, second side surface electrode 43, and second electroconductive resin layer 52. Second metallic plated layer 44 is higher in thermal conductivity than insulating protective layer 50.

In the plan view of first main surface 11 of insulating substrate 10, second metallic plated layer 44 has an end 44e closer to first front electrode 31 than second centerline 23c of second resistive element 23 in the first direction (x direction). In the plan view of first main surface 11 of insulating substrate 10, end 44e of second metallic plated layer 44 is a proximal end of second metallic plated layer 44 to intermediate electrode 26. In the plan view of first main surface 11 of insulating substrate 10, end 44e of second metallic plated layer 44 is a distal end of second metallic plated layer 44 from second side surface 14 of insulating substrate 10. Second metallic plated layer 44 includes, for example, a second inner plated layer 45, a second intermediate plated layer 46, and a second outer plated layer 47.

Second inner plated layer 45 is formed on second front electrode 41, second back electrode 42, second side surface electrode 43, and second electroconductive resin layer 52. Second inner plated layer 45 is in contact with second front electrode 41, second back electrode 42, second side surface electrode 43, and second electroconductive resin layer 52. Second inner plated layer 45 is, for example, a copper plated layer.

Second intermediate plated layer 46 is formed on second inner plated layer 45 to cover second inner plated layer 45. Second intermediate plated layer 46 protects second front electrode 41, second back electrode 42, second side surface electrode 43, and second inner plated layer 45 against heat and impact. Second intermediate plated layer 46 is, for example, a nickel plated layer.

Second outer plated layer 47 is formed on second intermediate plated layer 46 to cover second intermediate plated layer 46. Second outer plated layer 47 is formed of a material to which a conductive bonding member 65 (see FIG. 3) such as solder is more readily attached than to second intermediate plated layer 46. Second outer plated layer 47 is, for example, a tin plated layer. Conductive bonding member 65 is attached to second outer plated layer 47 and an electrical wire 63 of wiring board 60 (see FIG. 3), so that chip resistor 1 is mounted on wiring board 60.

Referring to FIG. 3, chip resistor 1 is mounted, for example, on wiring board 60. Specifically, wiring board 60 includes an insulating substrate 61 and electrical wires 62 and 63. First electrode 30 of chip resistor 1 is bonded to electrical wire 62 of wiring board 60 with the use of conductive bonding member 64 such as solder. Second electrode 40 of chip resistor 1 is bonded to electrical wire 63 of wiring board 60 with the use of conductive bonding member 65 such as solder.

An exemplary method of manufacturing chip resistor 1 in the present embodiment will be described with reference to FIGS. 1, 2, and 4 to 8.

Referring to FIG. 4, first front electrode 31, second front electrode 41, and intermediate electrode 26 are formed on first main surface 11 of insulating substrate 10. First front electrode 31, second front electrode 41, and intermediate electrode 26 are formed, for example, by printing a paste containing silver onto first main surface 11 of insulating substrate 10 and firing the paste. Intermediate electrode 26 is formed closer to second front electrode 41 than first front electrode 31 in the direction of alignment (the first direction (x direction)) of first front electrode 31, intermediate electrode 26, and second front electrode 41. First back electrode 32 and second back electrode 42 are formed on second main surface 12 of insulating substrate 10. First back electrode 32 and second back electrode 42 are formed, for example, by printing a paste containing silver onto second main surface 12 of insulating substrate 10 and firing the paste.

Referring to FIG. 5, first resistive element 20 and second resistive element 23 are formed on first main surface 11 of insulating substrate 10. First resistive element 20 and second resistive element 23 are formed by printing and firing a paste obtained by incorporating glass frit in an electrically resistive material such as ruthenium oxide (RuO₂) or a silver-palladium alloy. First resistive element 20 is in contact with first front electrode 31 and intermediate electrode 26. Second resistive element 23 is in contact with second front electrode 41 and intermediate electrode 26. First resistive element 20 and second resistive element 23 may be formed on first main surface 11 of insulating substrate 10, and then first front electrode 31, second front electrode 41, intermediate electrode 26, first back electrode 32, and second back electrode 42 may be formed.

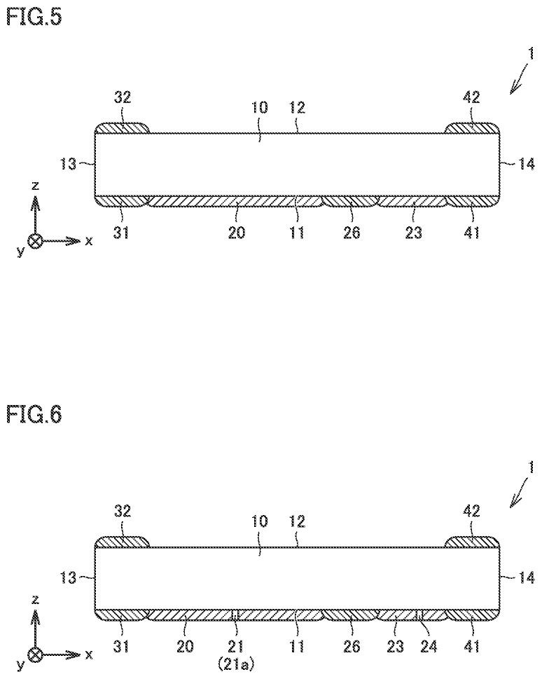

Referring to FIG. 6, second trimming groove 24 is provided in second resistive element 23. Second trimming groove 24 is provided, for example, by irradiating second resistive element 23 with laser beams. First trimming groove 21 is then provided in first resistive element 20. First trimming groove 21 is provided, for example, by irradiating first resistive element 20 with laser beams. When a target resistance value of chip resistor 1 is achieved, provision of first trimming groove 21 ends.

As described already, the material that forms first front electrode 31 has been diffused in a part of first resistive element 20. Therefore, the electric resistivity of first resistive element 20 gradually lowers from first centerline 20c of first resistive element 20 toward first front electrode 31. Therefore, by providing trimming groove portion 21a and then providing trimming groove portion 21b from trimming groove portion 21a toward first front electrode 31, the rate of change in electric resistivity of first resistive element 20 per unit length of trimming groove portion 21b becomes lower. The electric resistivity of first resistive element 20 can more accurately be set. The electric resistivity of chip resistor 1 can more accurately be set.

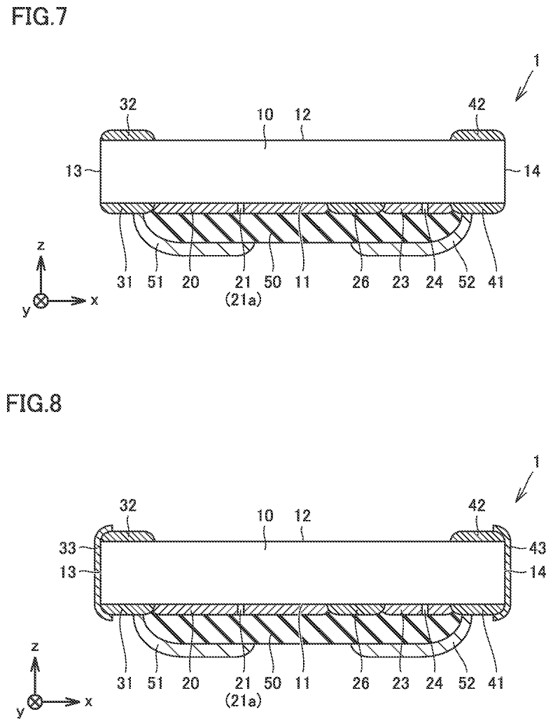

Referring to FIG. 7, insulating protective layer 50 is formed on first front electrode 31, first resistive element 20, intermediate electrode 26, second resistive element 23, and second front electrode 41. Specifically, insulating protective layer 50 is formed by printing a paste containing an insulating resin such as an epoxy resin onto first front electrode 31, first resistive element 20, intermediate electrode 26, second resistive element 23, and second front electrode 41 and curing the paste. First electroconductive resin layer 51 and second electroconductive resin layer 52 are then formed. Specifically, first electroconductive resin layer 51 is formed by printing a paste containing the binder resin and electroconductive particles on insulating protective layer 50 and first front electrode 31 and curing the paste. Second electroconductive resin layer 52 is formed by printing a paste containing the binder resin and electroconductive particles on insulating protective layer 50 and second front electrode 41 and curing the paste.

Referring to FIGS. 1, 2, and 8, first electrode 30 and second electrode 40 are formed.

Specifically, referring to FIG. 8, first side surface electrode 33 and second side surface electrode 43 are formed. First side surface electrode 33 is formed on first side surface 13 of insulating substrate 10, first front electrode 31, and first back electrode 32, for example, by physical vapor deposition (PVD) such as sputtering. First side surface electrode 33 is in contact with first front electrode 31 and first back electrode 32 to electrically conduct to first front electrode 31 and first back electrode 32. Second side surface electrode 43 is formed on second side surface 14 of insulating substrate 10, second front electrode 41, and second back electrode 42, for example, by physical vapor deposition (PVD) such as sputtering. Second side surface electrode 43 is in contact with second front electrode 41 and second back electrode 42 to electrically conduct to second front electrode 41 and second back electrode 42.

Referring to FIGS. 1 and 2, first metallic plated layer 34 and second metallic plated layer 44 are formed. First metallic plated layer 34 includes, for example, first inner plated layer 35, first intermediate plated layer 36, and first outer plated layer 37. Second metallic plated layer 44 includes, for example, second inner plated layer 45, second intermediate plated layer 46, and second outer plated layer 47.

Specifically, first inner plated layer 35 is formed on first front electrode 31, first back electrode 32, first side surface electrode 33, and first electroconductive resin layer 51. Second inner plated layer 45 is formed on second front electrode 41, second back electrode 42, second side surface electrode 43, and second electroconductive resin layer 52. First inner plated layer 35 and second inner plated layer 45 are each, for example, the copper plated layer. First intermediate plated layer 36 is then formed on first inner plated layer 35. Second intermediate plated layer 46 is formed on second inner plated layer 45. First intermediate plated layer 36 and second intermediate plated layer 46 are each, for example, the nickel plated layer. First outer plated layer 37 is then formed on first intermediate plated layer 36. Second outer plated layer 47 is formed on second intermediate plated layer 46. First outer plated layer 37 and second outer plated layer 47 are each, for example, the tin plated layer. Chip resistor 1 is thus obtained.

Functions of chip resistor 1 in the present embodiment will be described in comparison to a chip resistor in a first comparative example and a chip resistor in a second comparative example.

As a current flows through the chip resistor, the resistive element generates heat. In the chip resistor in the first comparative example, a single resistive element is provided at the center of insulating substrate 10 in the longitudinal direction (first direction (x direction)) of insulating substrate 10 and the entire resistive element is covered with insulating protective layer 50. The center of insulating substrate 10 is most separated from first side surface 13 and second side surface 14. While the chip resistor in the first comparative example is used, a temperature at the center of the chip resistor in the first comparative example significantly increases. Short time overload (STOL) characteristics of the chip resistor in the first comparative example are insufficient.

In contrast, chip resistor 1 in the present embodiment includes first resistive element 20 and second resistive element 23. First resistive element 20 is arranged closer to first side surface 13 of insulating substrate 10 than the single resistive element in the first comparative example, and second resistive element 23 is arranged closer to second side surface 14 of insulating substrate 10 than the single resistive element in the first comparative example. Therefore, heat generated in first resistive element 20 and second resistive element 23 while chip resistor 1 is used can more quickly be radiated to the outside of chip resistor 1 (for example, wiring board 60 (see FIG. 3) or an ambient environment around chip resistor 1 such as ambient air around chip resistor 1). Increase in temperature at the center of chip resistor 1 while chip resistor 1 is used can thus be suppressed. The short time overload (STOL) characteristics of chip resistor 1 can be improved.

The chip resistor in the second comparative example includes first resistive element 20, second resistive element 23, and intermediate electrode 26 similarly to chip resistor 1 in the present embodiment, whereas it is different from chip resistor 1 in the present embodiment in that first length L₁ of first resistive element 20 in the first direction (x direction) is equal to second length L₂ of second resistive element 23 in the first direction (x direction).

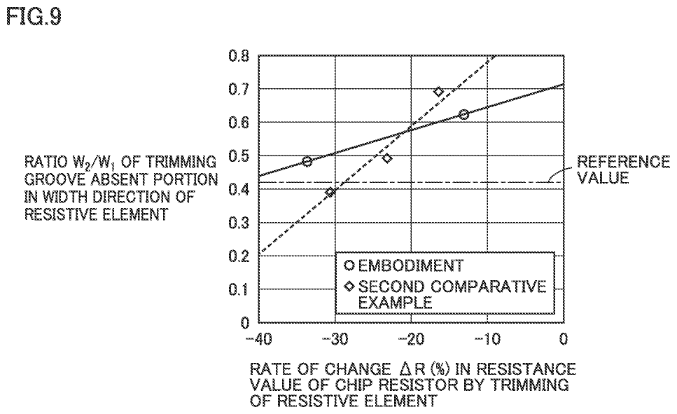

As the ratio of the trimming groove absent portion in the width direction (second direction (y direction)) of the resistive element is higher, heat generated in the resistive element decreases and the short time overload (STOL) characteristics of the chip resistor are improved. Therefore, in order to improve the short time overload (STOL) characteristics of the chip resistor, the ratio of the trimming groove absent portion in the width direction (second direction (y direction)) of the resistive element should be equal to or larger than a reference value (0.42 in FIG. 9 by way of example) even when a rate of change ΔR in resistance value of the chip resistor due to trimming of the resistive element is high. The ratio of the trimming groove absent portion in the width direction (second direction (y direction)) of the resistive element means a ratio of a portion of the resistive element where no trimming groove is provided in the width direction of the resistive element.

Rate of change ΔR in resistance value of the chip resistor due to trimming of the resistive element is given in an expression (1) below. Rᵢ represents an initial resistance value of chip resistor 1 before first trimming groove 21 and second trimming groove 24 are provided. Rₜ represents a target resistance value of chip resistor 1 to be achieved by providing first trimming groove 21 and second trimming groove 24.

ΔR=(Rᵢ−Rₜ)/Rₜ (1)

First length L₁ of first resistive element 20 of chip resistor 1 in the present embodiment in the first direction (x direction) is longer than first length L₁ of first resistive element 20 of the chip resistor in the second comparative example in the first direction (x direction). Therefore, in chip resistor 1 in the present embodiment, a length of trimming groove portion 21b of first trimming groove 21, the longitudinal direction of which extends along the first direction (x direction), can be longer than in the chip resistor in the second comparative example. In the present embodiment, the resistance value of chip resistor 1 can be closer to target resistance value Rₜ while the ratio of the trimming groove absent portion in the width direction (second direction (y direction)) of the resistive element is increased in providing first trimming groove 21. In other words, as shown in FIG. 9, even when rate of change ΔR in resistance value of the chip resistor due to trimming of the resistive element is high, the ratio of the trimming groove absent portion in the width direction (second direction (y direction)) of the resistive element can be equal to or larger than the reference value. The short time overload (STOL) characteristics of chip resistor 1 can thus be improved.

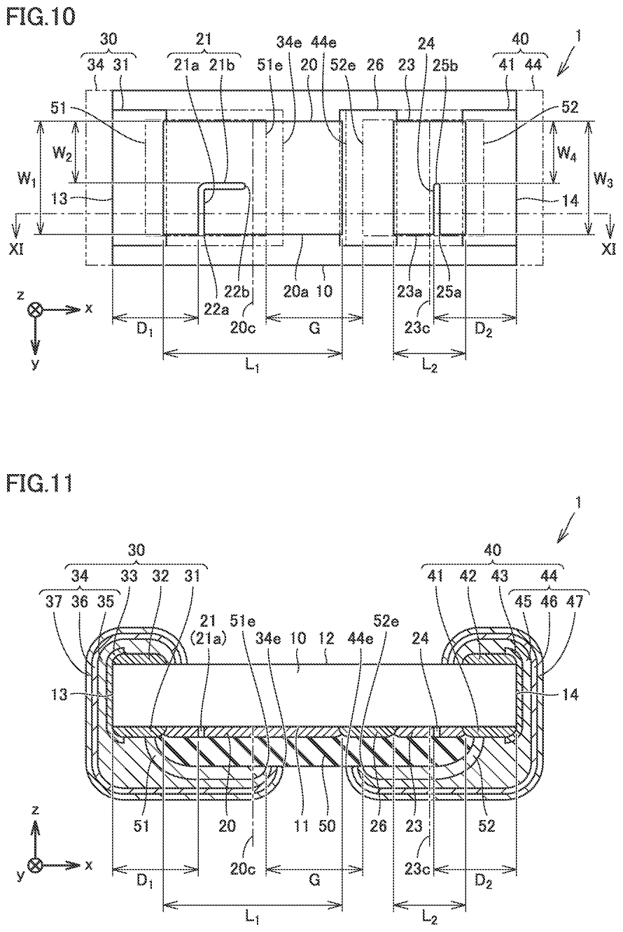

Referring to FIGS. 10 and 11, in a modification of the present embodiment, first trimming groove 21 may be provided as below. Trimming groove portions 21a and 21b are provided on a side closer to first front electrode 31 than first centerline 20c of first resistive element 20. In the first direction (x direction), trimming groove portion 21a is provided closer to first front electrode 31 than trimming groove portion 21b. In the first direction (x direction), trimming groove portion 21b is provided closer to intermediate electrode 26 than trimming groove portion 21a. Trimming groove portion 21b is provided closer to first centerline 20c of first resistive element 20 than trimming groove portion 21a. In the plan view of first main surface 11 of insulating substrate 10, trimming groove portion 21b extends from trimming groove portion 21a toward intermediate electrode 26.

In the plan view of first main surface 11 of insulating substrate 10, first trimming groove 21 is provided closer to first front electrode 31 and first side surface 13 than first centerline 20c of first resistive element 20 in the first direction (x direction). In the plan view of first main surface 11 of insulating substrate 10, a first distance D₁ between first trimming groove 21 and first side surface 13 is, for example, 400 μm or shorter. First distance D₁ is the shortest distance between first trimming groove 21 and first side surface 13 in the plan view of first main surface 11 of insulating substrate 10. First distance D₁ may be 300 μm or shorter.

Effects of chip resistor 1 in the present embodiment will be described.

Chip resistor 1 in the present embodiment includes insulating substrate 10, first electrode 30, second electrode 40, first resistive element 20, second resistive element 23, and intermediate electrode 26. Insulating substrate 10 is provided with first main surface 11, first side surface 13, and second side surface 14 opposite to first side surface 13. First side surface 13 and second side surface 14 are each connected to first main surface 11. In the plan view of first main surface 11 of insulating substrate 10, first electrode 30 is provided closer to first side surface 13 than second electrode 40. First electrode 30 includes first front electrode 31 provided on first main surface 11. Second electrode 40 is separated from first electrode 30 and provided closer to second side surface 14 than first electrode 30 in the plan view of first main surface 11. Second electrode 40 includes second front electrode 41 provided on first main surface 11, second front electrode 41 being separated from first front electrode 31. First resistive element 20 is provided on first main surface 11 and in contact with first front electrode 31 and intermediate electrode 26. Second resistive element 23 is provided on first main surface 11, separated from first resistive element 20, and in contact with second front electrode 41 and intermediate electrode 26. First length L₁ of first resistive element 20 in the first direction (x direction) in which first resistive element 20 and second resistive element 23 are separated from each other is longer than second length L₂ of second resistive element 23 in the first direction (x direction). Intermediate electrode 26 is provided on first main surface 11 of insulating substrate 10 and arranged between first resistive element 20 and second resistive element 23. First trimming groove 21 is provided in first resistive element 20. Second trimming groove 24 is provided in second resistive element 23.

First resistive element 20 is arranged closer to first side surface 13 of insulating substrate 10 and second resistive element 23 is arranged closer to second side surface 14 of insulating substrate 10. Therefore, heat generated in first resistive element 20 and second resistive element 23 while chip resistor 1 is used can more quickly be radiated to the outside of chip resistor 1. In addition, since first length L₁ of first resistive element 20 is longer than second length L₂ of second resistive element 23, the length of trimming groove portion 21b of first trimming groove 21, the longitudinal direction of which extends along the first direction (x direction), can be longer. While the ratio of the trimming groove absent portion in the width direction (second direction (y direction)) of the resistive element is increased in providing first trimming groove 21, the resistance value of chip resistor 1 can be closer to target resistance value Rₜ. Therefore, the short time overload (STOL) characteristics of chip resistor 1 can be improved.

In chip resistor 1 in the present embodiment, first length L₁ of first resistive element 20 is at least 1.2 time as long as second length L₂ of second resistive element 23.

Therefore, the length of trimming groove portion 21b of first trimming groove 21, the longitudinal direction of which extends along the first direction (x direction), can be longer. While the ratio of the trimming groove absent portion in the width direction (second direction (y direction)) of the resistive element is increased in providing first trimming groove 21, the resistance value of chip resistor 1 can be closer to target resistance value Rₜ. The short time overload (STOL) characteristics of chip resistor 1 can be improved.

In chip resistor 1 in the present embodiment, first length L₁ of first resistive element 20 is at least 1.5 time as long as second length L₂ of second resistive element 23.

Therefore, the length of trimming groove portion 21b of first trimming groove 21, the longitudinal direction of which extends along the first direction (x direction), can be longer. While the ratio of the trimming groove absent portion in the width direction (second direction (y direction)) of the resistive element is increased in providing first trimming groove 21, the resistance value of chip resistor 1 can be closer to target resistance value Rₜ. The short time overload (STOL) characteristics of chip resistor 1 can be improved.

In chip resistor 1 in the present embodiment, first trimming groove 21 includes a first trimming groove portion (trimming groove portion 21a) and a second trimming groove portion (trimming groove portion 21b) connected to the first trimming groove portion. In the plan view of first main surface 11 of insulating substrate 10, the longitudinal direction of the first trimming groove portion extends along the second direction perpendicular to the first direction (x direction). In the plan view of first main surface 11 of insulating substrate 10, the longitudinal direction of the second trimming groove portion extends along the first direction (x direction). In the plan view of first main surface 11 of insulating substrate 10, the longitudinal direction of second trimming groove 24 extends along the second direction (y direction).

Therefore, while the ratio of the trimming groove absent portion in the width direction (second direction (y direction)) of the resistive element is increased in providing first trimming groove 21, the resistance value of chip resistor 1 can be closer to target resistance value Rₜ. The short time overload (STOL) characteristics of chip resistor 1 can be improved.

In chip resistor 1 in the present embodiment, first ratio W₂/W₁ of the trimming groove absent portion in first resistive element 20 in the second direction (y direction) perpendicular to the first direction (x direction) in the plan view of first main surface 11 is substantially equal to second ratio W₄/W₃ of the trimming groove absent portion in second resistive element 23 in the second direction.

Therefore, a temperature difference between first resistive element 20 and second resistive element 23 when a current flows through chip resistor 1 decreases. The short time overload (STOL) characteristics of chip resistor 1 can be improved and accuracy in detection of the current in chip resistor 1 can be improved.

In chip resistor 1 in the present embodiment, the first trimming groove portion (trimming groove portion 21a) is provided on first centerline 20c of first resistive element 20 in the first direction (x direction) or close to first front electrode 31 with respect to first centerline 20c. The second trimming groove portion (trimming groove portion 21b) extends from the first trimming groove portion toward first front electrode 31.

The material that forms first front electrode 31 is diffused in a part of first resistive element 20. The electric resistivity of first resistive element 20 gradually lowers from first centerline 20c of first resistive element 20 toward first front electrode 31. Therefore, the rate of change in electric resistivity of first resistive element 20 per unit length of trimming groove portion 21b lowers. The electric resistivity of first resistive element 20 can more accurately be set. The electric resistivity of chip resistor 1 can more accurately be set.

In chip resistor 1 in the present embodiment, first trimming groove 21 is provided close to first front electrode 31 and first side surface 13 with respect to first centerline 20c of first resistive element 20 in the first direction (x direction). Second trimming groove 24 is provided close to second front electrode 41 and second side surface 14 with respect to second centerline 23c of second resistive element 23 in the first direction (x direction).

As a current flows through chip resistor 1, a temperature of a portion of first resistive element 20 around first trimming groove 21 is highest in first resistive element 20 and a temperature of a portion of second resistive element 23 around second trimming groove 24 is highest in second resistive element 23. In chip resistor 1, first trimming groove 21 is arranged closer to first side surface 13 of insulating substrate 10 and second trimming groove 24 is arranged closer to second side surface 14 of insulating substrate 10. Therefore, heat generated in the portion of first resistive element 20 around first trimming groove 21 and the portion of second resistive element 23 around second trimming groove 24 can more quickly be radiated to the outside of chip resistor 1. Increase in temperature of chip resistor 1 while chip resistor 1 is used can be suppressed. The short time overload (STOL) characteristics of chip resistor 1 can be improved.

In chip resistor 1 in the present embodiment, the first distance between first trimming groove 21 and first side surface 13 is 400 μm or shorter. The second distance between second trimming groove 24 and second side surface 14 is 400 μm or shorter.

Therefore, in chip resistor 1, first trimming groove 21 is arranged closer to first side surface 13 of insulating substrate 10 and second trimming groove 24 is arranged closer to second side surface 14 of insulating substrate 10. Heat generated in the portion of first resistive element 20 around first trimming groove 21 and the portion of second resistive element 23 around second trimming groove 24 can more quickly be radiated to the outside of chip resistor 1. Increase in temperature of chip resistor 1 while chip resistor 1 is used can be suppressed. The short time overload (STOL) characteristics of chip resistor 1 can be improved.

Chip resistor 1 in the present embodiment further includes insulating protective layer 50, first electroconductive resin layer 51, and second electroconductive resin layer 52. Insulating protective layer 50 is provided on first resistive element 20, second resistive element 23, and intermediate electrode 26. First electroconductive resin layer 51 is higher in thermal conductivity than insulating protective layer 50. First electroconductive resin layer 51 is provided on first front electrode 31 and insulating protective layer 50 and covers at least a part of first resistive element 20 in the plan view of first main surface 11 of insulating substrate 10. Second electroconductive resin layer 52 is separated from first electroconductive resin layer 51 and higher in thermal conductivity than insulating protective layer 50. Second electroconductive resin layer 52 is provided on second front electrode 41 and insulating protective layer 50 and covers at least a part of second resistive element 23 in the plan view of first main surface 11 of insulating substrate 10. Insulating protective layer 50 electrically isolates first electrode 30 and second electrode 40 from each other and electrically isolates first electroconductive resin layer 51 and second electroconductive resin layer 52 from each other. In the plan view of first main surface 11 of insulating substrate 10, first electroconductive resin layer 51 covers at least a part of first trimming groove 21 and second electroconductive resin layer 52 covers at least a part of second trimming groove 24.

First electroconductive resin layer 51 is provided on first front electrode 31, covers at least a part of first resistive element 20 in the plan view of first main surface 11 of insulating substrate 10, and is higher in thermal conductivity than insulating protective layer 50. Second electroconductive resin layer 52 is provided on second front electrode 41, covers at least a part of second resistive element 23 in the plan view of first main surface 11 of insulating substrate 10, and is higher in thermal conductivity than insulating protective layer 50. Therefore, heat generated in first resistive element 20 and second resistive element 23 while chip resistor 1 is used can more quickly be radiated to the outside of chip resistor 1. In the plan view of first main surface 11, first electroconductive resin layer 51 covers at least a part of first trimming groove 21 and second electroconductive resin layer 52 covers at least a part of second trimming groove 24. Therefore, heat generated in the portion of first resistive element 20 around first trimming groove 21 and the portion of second resistive element 23 around second trimming groove 24 can more quickly be radiated to the outside of chip resistor 1. Increase in temperature of chip resistor 1 while chip resistor 1 is used can thus be suppressed. The short time overload (STOL) characteristics of chip resistor 1 can be improved.

In chip resistor 1 in the present embodiment, in the plan view of first main surface 11 of insulating substrate 10, first electroconductive resin layer 51 covers at least 20% of the area of first resistive element 20 and second electroconductive resin layer 52 covers at least 20% of the area of second resistive element 23.

Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, in the plan view of first main surface 11 of insulating substrate 10, first electroconductive resin layer 51 covers at least 50% of the entire length of first trimming groove 21 and second electroconductive resin layer 52 covers at least 50% of the entire length of second trimming groove 24.

Therefore, first electroconductive resin layer 51 and second electroconductive resin layer 52 can more quickly radiate to the outside of chip resistor 1, heat generated in the portion of first resistive element 20 around first trimming groove 21 and the portion of second resistive element 23 around second trimming groove 24 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, in the plan view of first main surface 11 of insulating substrate 10, first electroconductive resin layer 51 covers the entirety of first trimming groove 21 and second electroconductive resin layer 52 covers the entirety of second trimming groove 24.

Therefore, first electroconductive resin layer 51 and second electroconductive resin layer 52 can more quickly radiate to the outside of chip resistor 1, heat generated in the portion of first resistive element 20 around first trimming groove 21 and the portion of second resistive element 23 around second trimming groove 24 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, the interval between first electroconductive resin layer 51 and second electroconductive resin layer 52 is 300 μm or larger.

Therefore, contact between first electroconductive resin layer 51 and second electroconductive resin layer 52 and resultant electrical short-circuiting between first electroconductive resin layer 51 and second electroconductive resin layer 52 in formation of first electroconductive resin layer 51 and second electroconductive resin layer 52 can more reliably be prevented.

In chip resistor 1 in the present embodiment, in the plan view of first main surface 11 of insulating substrate 10, first electroconductive resin layer 51 has a first end (end 51e) closer to second front electrode 41 than first centerline 20c of first resistive element 20 in the first direction (x direction) and second electroconductive resin layer 52 has a second end (end 52e) closer to first front electrode 31 than second centerline 23c of second resistive element 23 in the first direction (x direction). In the plan view of first main surface 11 of insulating substrate 10, the first end (end 51e) of first electroconductive resin layer 51 is the distal end of first electroconductive resin layer 51 from first side surface 13. In the plan view of first main surface 11 of insulating substrate 10, the second end (end 52e) of second electroconductive resin layer 52 is the distal end of second electroconductive resin layer 52 from second side surface 14.

Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature at the center of chip resistor 1 while chip resistor 1 is used can be suppressed. The short time overload (STOL) characteristics of chip resistor 1 can be improved.

In chip resistor 1 in the present embodiment, first electrode 30 further includes first metallic plated layer 34. Second electrode 40 further includes second metallic plated layer 44. First metallic plated layer 34 is provided on first front electrode 31 and first electroconductive resin layer 51 and higher in thermal conductivity than insulating protective layer 50. Second metallic plated layers 44 is provided on second front electrode 41 and second electroconductive resin layer 52 and higher in thermal conductivity than insulating protective layer 50. In the plan view of first main surface 11 of insulating substrate 10, first metallic plated layer 34 has a third end (end 34e) closer to second front electrode 41 than first centerline 20c of first resistive element 20 in the first direction (x direction) and second metallic plated layer 44 has a fourth end (end 44e) closer to first front electrode 31 than second centerline 23c of second resistive element 23 in the first direction (x direction). In the plan view of first main surface 11 of insulating substrate 10, the third end (end 34e) of first metallic plated layer 34 is the proximal end of first metallic plated layer 34 to intermediate electrode 26. In the plan view of first main surface 11 of insulating substrate 10, the fourth end (end 44e) of second metallic plated layer 44 is the proximal end of second metallic plated layer 44 to intermediate electrode 26.

Therefore, first metallic plated layer 34 and second metallic plated layer 44 can more quickly radiate to the outside of chip resistor 1, heat generated in first resistive element 20 and second resistive element 23 while chip resistor 1 is used. Increase in temperature at the center of chip resistor 1 while chip resistor 1 is used can be suppressed. The short time overload (STOL) characteristics of chip resistor 1 can be improved.

In chip resistor 1 in the present embodiment, insulating substrate 10 is provided with second main surface 12 opposite to first main surface 11. First electrode 30 includes first back electrode 32 provided on second main surface 12. Second electrode 40 includes second back electrode 42 provided on second main surface 12. First metallic plated layer 34 is in contact with first front electrode 31 and first back electrode 32. Second metallic plated layer 44 is in contact with second front electrode 41 and second back electrode 42.

First back electrode 32 can more quickly radiate heat generated in first resistive element 20 to the outside of chip resistor 1. Second back electrode 42 can more quickly radiate heat generated in second resistive element 23 to the outside of chip resistor 1. Increase in temperature of chip resistor 1 while chip resistor 1 is used can be suppressed. The short time overload (STOL) characteristics of chip resistor 1 can be improved.

In chip resistor 1 in the present embodiment, first metallic plated layer 34 includes a first copper plated layer in contact with first front electrode 31. Second metallic plated layer 44 includes a second copper plated layer in contact with second front electrode 41.

Copper has a thermal conductivity of 398 W/(m·K), and the copper plated layer has the very high thermal conductivity. Therefore, first metallic plated layer 34 can more quickly radiate heat generated in first resistive element 20 to the outside of chip resistor 1. Second metallic plated layer 44 can more quickly radiate heat generated in second resistive element 23 to the outside of chip resistor 1. Increase in temperature of chip resistor 1 while chip resistor 1 is used can be suppressed. The short time overload (STOL) characteristics of chip resistor 1 can be improved.

In chip resistor 1 in the present embodiment, first electroconductive resin layer 51 and second electroconductive resin layer 52 each include the binder resin and electroconductive particles added to the binder resin.

Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, the binder resin is formed of the epoxy resin, the phenol resin, or combination thereof. The electroconductive particles are carbon particles, metallic particles, or combination thereof.

Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature of chip resistor 1 while chip resistor 1 is used can be suppressed. The short time overload (STOL) characteristics of chip resistor 1 can be improved.

### Second Embodiment

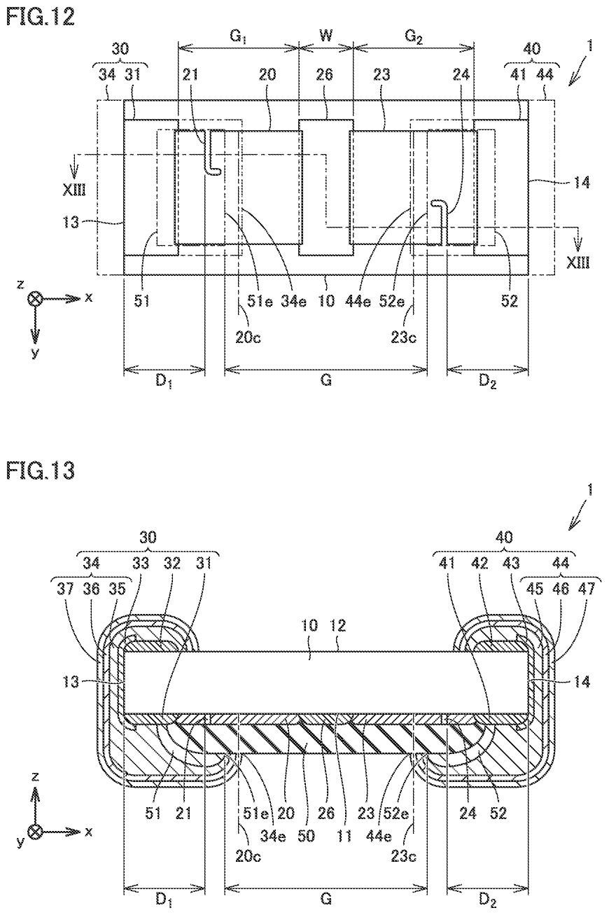

Chip resistor 1 in a second embodiment will be described with reference to FIGS. 12 and 13. Chip resistor 1 includes insulating substrate 10, first electrode 30, second electrode 40, first resistive element 20, second resistive element 23, intermediate electrode 26, insulating protective layer 50, first electroconductive resin layer 51, and second electroconductive resin layer 52. FIG. 12 does not show insulating protective layer 50 for the sake of convenience.

Insulating substrate 10 is formed of an electrically insulating material such as alumina (Al₂O₃). Insulating substrate 10 is provided with first main surface 11, second main surface 12 opposite to first main surface 11, first side surface 13, and second side surface 14 opposite to first side surface 13. First side surface 13 and second side surface 14 are each connected to first main surface 11 and second main surface 12. First main surface 11 and second main surface 12 each extend along the first direction (x direction) and the second direction (y direction) perpendicular to the first direction. The first direction (x direction) is, for example, the longitudinal direction of insulating substrate 10. The first direction (x direction) is the direction in which first side surface 13 and second side surface 14 are separated from each other. The first direction (x direction) is the direction in which first resistive element 20 and second resistive element 23 are separated from each other. The first direction (x direction) is the direction in which first electrode 30 and second electrode 40 are separated from each other. The second direction (y direction) is, for example, the direction of the short side of insulating substrate 10. First main surface 11 and second main surface 12 are separated from each other in the third direction (z direction) perpendicular to the first direction (x direction) and the second direction (y direction). The third direction (z direction) is the direction of thickness of insulating substrate 10.

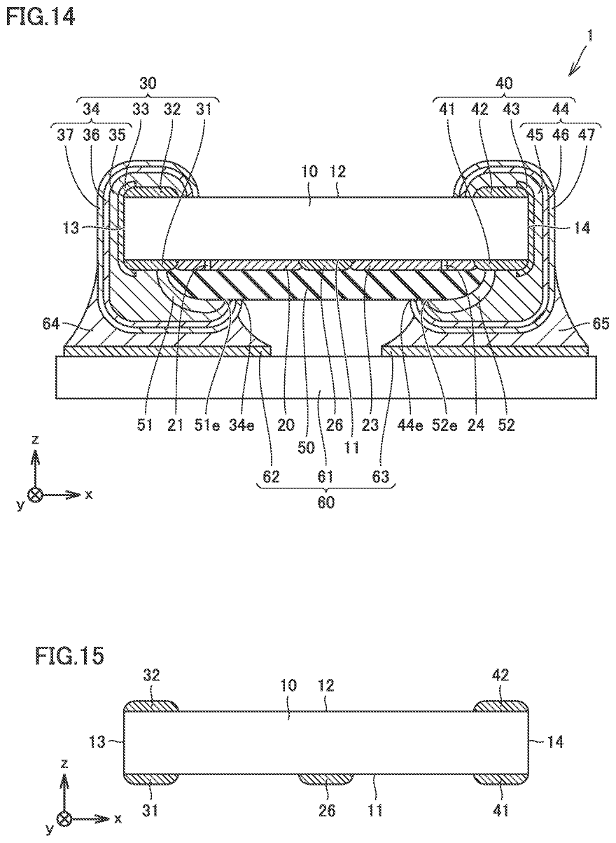

Referring to FIG. 14, in mount of chip resistor 1 on wiring board 60, first main surface 11 faces wiring board 60. In other words, first main surface 11 is the mount surface used in mount of chip resistor 1 on wiring board 60. First main surface 11 is the carrying surface on which first resistive element 20 and second resistive element 23 are carried.

First resistive element 20 and second resistive element 23 perform the function to restrict a current or the function to detect a current. First resistive element 20 and second resistive element 23 are provided on first main surface 11 of insulating substrate 10. First resistive element 20 and second resistive element 23 are formed, for example, by printing the paste obtained by incorporating glass frit in an electrically resistive material such as ruthenium oxide (RuO₂) or a silver-palladium alloy onto first main surface 11 of insulating substrate 10 and firing the paste. Each of first resistive element 20 and second resistive element 23 is, for example, in a rectangular shape in the plan view of first main surface 11 of insulating substrate 10. First resistive element 20 and second resistive element 23 are aligned in the first direction (the x direction, for example, in the longitudinal direction of insulating substrate 10).

First resistive element 20 is provided on the side of first side surface 13 of insulating substrate 10. First resistive element 20 is provided closer to first side surface 13 than second resistive element 23. First resistive element 20 is in contact with the first front electrode and intermediate electrode 26.

First resistive element 20 is provided with first trimming groove 21. Provision of first trimming groove 21 in first resistive element 20 allows accurate determination of the resistance value of chip resistor 1 (first resistive element 20). In the plan view of first main surface 11 of insulating substrate 10, first trimming groove 21 is, for example, in an L shape that extends in the first direction (x direction) and the second direction (y direction). First trimming groove 21 may be in a linear shape extending in the second direction (y direction).

In the plan view of first main surface 11 of insulating substrate 10, first trimming groove 21 is provided close to first front electrode 31 and first side surface 13 with respect to first centerline 20c of first resistive element 20 in the first direction (x direction). In the plan view of first main surface 11 of insulating substrate 10, first distance D₁ between first trimming groove 21 and first side surface 13 is, for example, 400 μm or shorter. First distance D₁ is the shortest distance between first trimming groove 21 and first side surface 13 in the plan view of first main surface 11 of insulating substrate 10. First distance D₁ may be 300 μm or shorter.

Second resistive element 23 is separated from first resistive element 20. Second resistive element 23 is provided on the side of second side surface 14 of insulating substrate 10. Second resistive element 23 is provided closer to second side surface 14 than first resistive element 20. Second resistive element 23 is in contact with second front electrode 41 and intermediate electrode 26.

Second trimming groove 24 is provided in second resistive element 23. Provision of second trimming groove 24 in second resistive element 23 allows accurate determination of the resistance value of chip resistor 1 (second resistive element 23). In the plan view of first main surface 11 of insulating substrate 10, second trimming groove 24 is, for example, in an L shape that extends in the first direction (x direction) and the second direction (y direction). Second trimming groove 24 may be in a linear shape extending in the second direction (y direction).

In the plan view of first main surface 11 of insulating substrate 10, second trimming groove 24 is provided close to second front electrode 41 and second side surface 14 with respect to second centerline 23c of second resistive element 23 in the first direction (x direction). In the plan view of first main surface 11 of insulating substrate 10, second distance D₂ between second trimming groove 24 and second side surface 14 is, for example, 400 μm or shorter. Second distance D₂ is the shortest distance between second trimming groove 24 and second side surface 14 in the plan view of first main surface 11 of insulating substrate 10. Second distance D₂ may be 300 μm or shorter.

Intermediate electrode 26 is provided on first main surface 11 of insulating substrate 10. Intermediate electrode 26 is arranged between first resistive element 20 and second resistive element 23. Intermediate electrode 26 is in contact with first resistive element 20 and second resistive element 23 to electrically connect first resistive element 20 and second resistive element 23 to each other in series. Intermediate electrode 26 is separated from first front electrode 31 and second front electrode 41. First front electrode 31, intermediate electrode 26, and second front electrode 41 are aligned in the first direction (x direction).

In the plan view of first main surface 11, intermediate electrode 26 may be superimposed on first resistive element 20 over a width of 100 μm or larger in the first direction (x direction). Therefore, even in consideration of a manufacturing error, intermediate electrode 26 can more reliably be in contact with first resistive element 20. In the plan view of first main surface 11, intermediate electrode 26 may be superimposed on second resistive element 23 over a width of 100 μm or larger in the first direction (x direction). Therefore, even in consideration of a manufacturing error, intermediate electrode 26 can more reliably be in contact with second resistive element 23. Intermediate electrode 26 may have width W in the first direction (x direction) equal to or larger than 300 μm. Therefore, contact between intermediate electrode 26 and first resistive element 20 and contact between intermediate electrode 26 and second resistive element 23 can be ensured and contact between first resistive element 20 and second resistive element 23 can more reliably be prevented.

Width W of intermediate electrode 26 may be determined such that interval G₁ between first front electrode 31 and intermediate electrode 26 in the first direction (x direction) is 300 μm or larger and interval G₂ between second front electrode 41 and intermediate electrode 26 in the first direction (x direction) is 300 μm or larger. Therefore, even in consideration of a diameter of laser beams and accuracy in position of laser beams used for providing first trimming groove 21 and second trimming groove 24, provision of first trimming groove 21 in first resistive element 20 and second trimming groove 24 in second resistive element 23 can be ensured and trimming of first front electrode 31, second front electrode 41, and intermediate electrode 26 by laser beams can more reliably be prevented.

Intermediate electrode 26 is formed, for example, by printing a conductive paste such as a paste obtained by incorporating glass frit in silver onto first main surface 11 of insulating substrate 10 and firing the conductive paste.

Insulating protective layer 50 is provided on first resistive element 20, second resistive element 23, and intermediate electrode 26. Insulating protective layer 50 may further be provided on first front electrode 31 and second front electrode 41. Insulating protective layer 50 electrically isolates first electrode 30 and second electrode 40 from each other. Insulating protective layer 50 electrically isolates first metallic plated layer 34 and second metallic plated layer 44 from each other. Insulating protective layer 50 electrically isolates first electroconductive resin layer 51 and second electroconductive resin layer 52 from each other. Insulating protective layer 50 is formed of an insulating resin such as an epoxy resin. Insulating protective layer 50 is formed, for example, by printing and curing a paste containing the insulating resin.

First electroconductive resin layer 51 is provided on first front electrode 31 and insulating protective layer 50. First electroconductive resin layer 51 covers at least a part of first resistive element 20 in the plan view of first main surface 11 of insulating substrate 10. In the plan view of first main surface 11 of insulating substrate 10, first electroconductive resin layer 51 covers, for example, at least 20% of the area of first resistive element 20. In the plan view of first main surface 11 of insulating substrate 10, first electroconductive resin layer 51 may cover at least 30% of the area of first resistive element 20 or at least 40% of the area of first resistive element 20.

In the plan view of first main surface 11 of insulating substrate 10, first electroconductive resin layer 51 may have end 51e closer to first side surface 13 and first front electrode 31 than first centerline 20c of first resistive element 20 in the first direction (x direction). In the plan view of first main surface 11 of insulating substrate 10, end 51e of first electroconductive resin layer 51 is the distal end of first electroconductive resin layer 51 from first side surface 13. In the plan view of first main surface 11 of insulating substrate 10, end 51e of first electroconductive resin layer 51 is the proximal end of first electroconductive resin layer 51 to intermediate electrode 26.

In the plan view of first main surface 11 of insulating substrate 10, first electroconductive resin layer 51 covers at least a part of first trimming groove 21. In the plan view of first main surface 11 of insulating substrate 10, first electroconductive resin layer 51 covers, for example, at least 50% of the entire length of first trimming groove 21. In the plan view of first main surface 11 of insulating substrate 10, first electroconductive resin layer 51 may cover the entirety of first trimming groove 21.

First electroconductive resin layer 51 contains a binder resin and electroconductive particles added to the binder resin. The binder resin is formed of an epoxy resin, a phenol resin, or combination thereof. The electroconductive particles are lower in electric resistivity than the binder resin. The electroconductive particles are, for example, metallic particles such as silver particles or copper particles, carbon particles, or combination thereof. First electroconductive resin layer 51 is formed, for example, by printing and curing a paste containing the binder resin and the electroconductive particles. The electroconductive particles are higher in thermal conductivity than the binder resin. First electroconductive resin layer 51 is higher in thermal conductivity than insulating protective layer 50.

Second electroconductive resin layer 52 is provided on second front electrode 41 and insulating protective layer 50. In the plan view of first main surface 11 of insulating substrate 10, second electroconductive resin layer 52 covers at least a part of second resistive element 23. In the plan view of first main surface 11 of insulating substrate 10, second electroconductive resin layer 52 covers, for example, at least 20% of the area of second resistive element 23. In the plan view of first main surface 11 of insulating substrate 10, second electroconductive resin layer 52 may cover at least 30% of the area of second resistive element 23 or at least 40% of the area of second resistive element 23.

In the plan view of first main surface 11 of insulating substrate 10, second electroconductive resin layer 52 may have end 52e closer to second side surface 14 and second front electrode 41 than second centerline 23c of second resistive element 23 in the first direction (x direction). In the plan view of first main surface 11 of insulating substrate 10, end 52e of second electroconductive resin layer 52 is the distal end of second electroconductive resin layer 52 from second side surface 14. In the plan view of first main surface 11 of insulating substrate 10, end 52e of second electroconductive resin layer 52 is the proximal end of second electroconductive resin layer 52 to intermediate electrode 26.

In the plan view of first main surface 11 of insulating substrate 10, second electroconductive resin layer 52 covers at least a part of second trimming groove 24. In the plan view of first main surface 11 of insulating substrate 10, second electroconductive resin layer 52 covers, for example, at least 50% of the entire length of second trimming groove 24. In the plan view of first main surface 11 of insulating substrate 10, second electroconductive resin layer 52 may cover the entirety of second trimming groove 24.

Second electroconductive resin layer 52 contains a binder resin and electroconductive particles added to the binder resin. The binder resin is formed of an epoxy resin, a phenol resin, or combination thereof. The electroconductive particles are lower in electric resistivity than the binder resin. The electroconductive particles are, for example, metallic particles such as silver particles or copper particles, carbon particles, or combination thereof. Second electroconductive resin layer 52 is formed, for example, by printing and curing a paste containing the binder resin and the electroconductive particles. The electroconductive particles are higher in thermal conductivity than the binder resin. Second electroconductive resin layer 52 is higher in thermal conductivity than insulating protective layer 50.

Second electroconductive resin layer 52 is separated from first electroconductive resin layer 51. An interval between first electroconductive resin layer 51 and second electroconductive resin layer 52 is, for example, 300 μm or larger. Therefore, contact between first electroconductive resin layer 51 and second electroconductive resin layer 52 and resultant electrical short-circuiting between first electroconductive resin layer 51 and second electroconductive resin layer 52 in formation of first electroconductive resin layer 51 and second electroconductive resin layer 52 can more reliably be prevented.

First electrode 30 is provided on the side of first side surface 13 of insulating substrate 10. In the plan view of first main surface 11 of insulating substrate 10, first electrode 30 is provided closer to first side surface 13 than second electrode 40. First electrode 30 includes first front electrode 31. First electrode 30 may further include first back electrode 32, first side surface electrode 33, and first metallic plated layer 34.

First front electrode 31 is provided on first main surface 11 of insulating substrate 10. First front electrode 31 is proximal to first side surface 13 relative to first resistive element 20. First front electrode 31 is in contact with first resistive element 20. In the plan view of first main surface 11 of insulating substrate 10, first front electrode 31 may extend to the ridgeline defined by first main surface 11 and first side surface 13. First front electrode 31 is formed, for example, by printing a paste containing silver onto first main surface 11 of insulating substrate 10 and firing the paste.

First back electrode 32 is provided on second main surface 12 of insulating substrate 10. In the plan view of first main surface 11 of insulating substrate 10, first back electrode 32 is superimposed on first front electrode 31. First back electrode 32 is formed, for example, by printing a paste containing silver onto second main surface 12 of insulating substrate 10 and firing the paste.

First side surface electrode 33 is provided on first side surface 13 of insulating substrate 10, first front electrode 31, and first back electrode 32. First side surface electrode 33 covers first side surface 13 of insulating substrate 10, first front electrode 31, and first back electrode 32. First side surface electrode 33 includes the first portion formed on first side surface 13 of insulating substrate 10, the second portion superimposed on first main surface 11 of insulating substrate 10 in the plan view in the direction of thickness (z direction) of insulating substrate 10, and the third portion superimposed on second main surface 12 of insulating substrate 10 in the plan view in the direction of thickness (z direction) of insulating substrate 10. First side surface electrode 33 electrically conducts to first front electrode 31 and first back electrode 32. First resistive element 20 electrically conducts to first back electrode 32 through first front electrode 31 and first side surface electrode 33. First side surface electrode 33 may be formed of a conductive material less likely to be sulfurized. First side surface electrode 33 is formed, for example, of an Ni—Cr alloy.

First metallic plated layer 34 is provided on first front electrode 31, first back electrode 32, first side surface electrode 33, and first electroconductive resin layer 51. First metallic plated layer 34 is in contact with first front electrode 31, first back electrode 32, first side surface electrode 33, and first electroconductive resin layer 51. First metallic plated layer 34 is higher in thermal conductivity than insulating protective layer 50.

In the plan view of first main surface 11 of insulating substrate 10, first metallic plated layer 34 has end 34e closer to second front electrode 41 than first centerline 20c of first resistive element 20 in the first direction (x direction). In the plan view of first main surface 11 of insulating substrate 10, end 34e of first metallic plated layer 34 is the proximal end of first metallic plated layer 34 to intermediate electrode 26. In the plan view of first main surface 11 of insulating substrate 10, end 34e of first metallic plated layer 34 is the distal end of first metallic plated layer 34 from first side surface 13 of insulating substrate 10. First metallic plated layer 34 includes, for example, first inner plated layer 35, first intermediate plated layer 36, and first outer plated layer 37.

First inner plated layer 35 is formed on first front electrode 31, first back electrode 32, first side surface electrode 33, and first electroconductive resin layer 51. First inner plated layer 35 is in contact with first front electrode 31, first back electrode 32, first side surface electrode 33, and first electroconductive resin layer 51. First inner plated layer 35 is, for example, the copper plated layer.

First intermediate plated layer 36 is formed on first inner plated layer 35 to cover first inner plated layer 35. First intermediate plated layer 36 protects first front electrode 31, first back electrode 32, first side surface electrode 33, and first inner plated layer 35 against heat and impact. First intermediate plated layer 36 is, for example, the nickel plated layer.

First outer plated layer 37 is formed on first intermediate plated layer 36 to cover first intermediate plated layer 36. First outer plated layer 37 is formed of a material to which conductive bonding member 64 (see FIG. 14) such as solder is more readily attached than to first intermediate plated layer 36. First outer plated layer 37 is, for example, the tin plated layer. Conductive bonding member 64 is attached to first outer plated layer 37 and electrical wire 62 of wiring board 60 (see FIG. 14), so that chip resistor 1 is mounted on wiring board 60.

Second electrode 40 is separated from first electrode 30. Second electrode 40 is provided on the side of second side surface 14 of insulating substrate 10. In the plan view of first main surface 11 of insulating substrate 10, second electrode 40 is provided closer to second side surface 14 than first electrode 30. Second electrode 40 includes second front electrode 41. Second electrode 40 may further include second back electrode 42, second side surface electrode 43, and second metallic plated layer 44.

Second front electrode 41 is provided on first main surface 11 of insulating substrate 10. Second front electrode 41 is separated from first front electrode 31. Second front electrode 41 is proximal to second side surface 14 relative to second resistive element 23. Second front electrode 41 is in contact with second resistive element 23. In the plan view of first main surface 11 of insulating substrate 10, second front electrode 41 may extend to the ridgeline defined by first main surface 11 and second side surface 14. Second front electrode 41 is formed, for example, by printing a paste containing silver onto first main surface 11 of insulating substrate 10 and firing the paste.

Second back electrode 42 is provided on second main surface 12 of insulating substrate 10. In the plan view of first main surface 11 of insulating substrate 10, second back electrode 42 is superimposed on second front electrode 41. Second back electrode 42 is formed, for example, by printing a paste containing silver onto second main surface 12 of insulating substrate 10 and firing the paste.

Second side surface electrode 43 is provided on second side surface 14 of insulating substrate 10, second front electrode 41, and second back electrode 42. Second side surface electrode 43 covers second side surface 14 of insulating substrate 10, second front electrode 41, and second back electrode 42. Second side surface electrode 43 includes the first portion formed on second side surface 14 of insulating substrate 10, the second portion superimposed on first main surface 11 of insulating substrate 10 in the plan view in the direction of thickness (z direction) of insulating substrate 10, and the third portion superimposed on second main surface 12 of insulating substrate 10 in the plan view in the direction of thickness (z direction) of insulating substrate 10. Second side surface electrode 43 electrically conducts to second front electrode 41 and second back electrode 42. Second resistive element 23 electrically conducts to second back electrode 42 through second front electrode 41 and second side surface electrode 33. Second side surface electrode 43 may be formed of a conductive material less likely to be sulfurized. Second side surface electrode 43 is formed, for example, of an Ni—Cr alloy.

Second metallic plated layer 44 is provided on second front electrode 41, second back electrode 42, second side surface electrode 43, and second electroconductive resin layer 52. Second metallic plated layer 44 is in contact with second front electrode 41, second back electrode 42, second side surface electrode 43, and second electroconductive resin layer 52. Second metallic plated layer 44 is higher in thermal conductivity than insulating protective layer 50.

In the plan view of first main surface 11 of insulating substrate 10, second metallic plated layer 44 has end 44e closer to first front electrode 31 than second centerline 23c of second resistive element 23 in the first direction (x direction). In the plan view of first main surface 11 of insulating substrate 10, end 44e of second metallic plated layer 44 is the proximal end of second metallic plated layer 44 to intermediate electrode 26. In the plan view of first main surface 11 of insulating substrate 10, end 44e of second metallic plated layer 44 is the distal end of second metallic plated layer 44 from second side surface 14 of insulating substrate 10. Second metallic plated layer 44 includes, for example, second inner plated layer 45, second intermediate plated layer 46, and second outer plated layer 47.

Second inner plated layer 45 is formed on second front electrode 41, second back electrode 42, second side surface electrode 43, and second electroconductive resin layer 52. Second inner plated layer 45 is in contact with second front electrode 41, second back electrode 42, second side surface electrode 43, and second electroconductive resin layer 52. Second inner plated layer 45 is, for example, the copper plated layer.

Second intermediate plated layer 46 is formed on second inner plated layer 45 to cover second inner plated layer 45. Second intermediate plated layer 46 protects second front electrode 41, second back electrode 42, second side surface electrode 43, and second inner plated layer 45 against heat and impact. Second intermediate plated layer 46 is, for example, the nickel plated layer.

Second outer plated layer 47 is formed on second intermediate plated layer 46 to cover second intermediate plated layer 46. Second outer plated layer 47 is formed of a material to which conductive bonding member 65 (see FIG. 14) such as solder is more readily attached than to second intermediate plated layer 46. Second outer plated layer 47 is, for example, the tin plated layer. Conductive bonding member 65 is attached to second outer plated layer 47 and electrical wire 63 of wiring board 60 (see FIG. 14), so that chip resistor 1 is mounted on wiring board 60.

Referring to FIG. 14, chip resistor 1 is mounted, for example, on wiring board 60. Specifically, wiring board 60 includes insulating substrate 61 and electrical wires 62 and 63. First electrode 30 of chip resistor 1 is bonded to electrical wire 62 of wiring board 60 with the use of conductive bonding member 64 such as solder. Second electrode 40 of chip resistor 1 is bonded to electrical wire 63 of wiring board 60 with the use of conductive bonding member 65 such as solder.

An exemplary method of manufacturing chip resistor 1 in the present embodiment will be described with reference to FIGS. 12, 13, and 15 to 19.

Referring to FIG. 15, first front electrode 31, second front electrode 41, and intermediate electrode 26 are formed on first main surface 11 of insulating substrate 10. First front electrode 31, second front electrode 41, and intermediate electrode 26 are formed, for example, by printing a paste containing silver onto first main surface 11 of insulating substrate 10 and firing the paste. First back electrode 32 and second back electrode 42 are formed on second main surface 12 of insulating substrate 10. First back electrode 32 and second back electrode 42 are formed, for example, by printing a paste containing silver onto second main surface 12 of insulating substrate 10 and firing the paste.

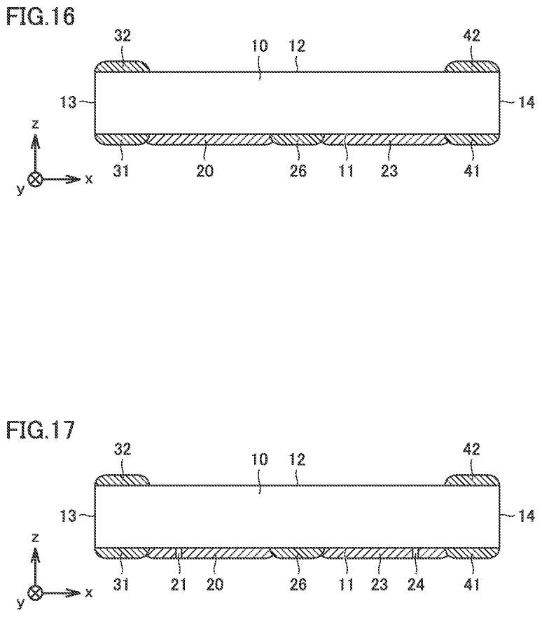

Referring to FIG. 16, first resistive element 20 and second resistive element 23 are formed on first main surface 11 of insulating substrate 10. First resistive element 20 and second resistive element 23 are formed by printing a paste obtained by incorporating glass frit in an electrically resistive material such as ruthenium oxide (RuO₂) or a silver-palladium alloy and firing the paste. First resistive element 20 is in contact with first front electrode 31 and intermediate electrode 26. Second resistive element 23 is in contact with second front electrode 41 and intermediate electrode 26. First resistive element 20 and second resistive element 23 may be formed on first main surface 11 of insulating substrate 10, and then first front electrode 31, second front electrode 41, intermediate electrode 26, first back electrode 32, and second back electrode 42 may be formed.

Referring to FIG. 17, first trimming groove 21 is provided in first resistive element 20 and second trimming groove 24 is provided in second resistive element 23. First trimming groove 21 is provided, for example, by irradiating first resistive element 20 with laser beams. Second trimming groove 24 is provided, for example, by irradiating second resistive element 23 with laser beams. When a target resistance value of chip resistor 1 is achieved, provision of first trimming groove 21 and second trimming groove 24 ends.

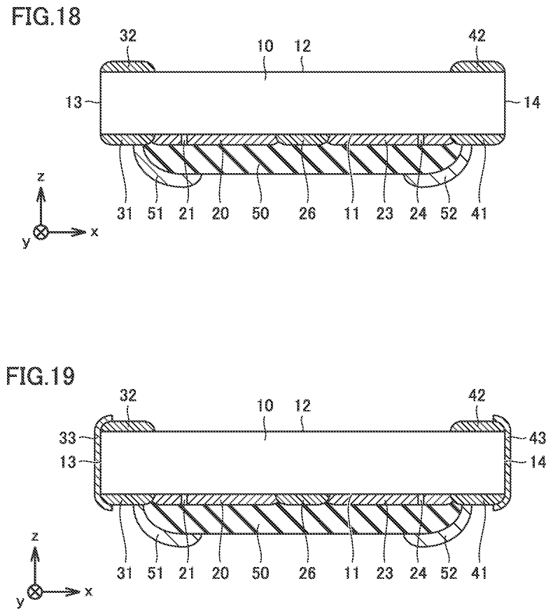

Referring to FIG. 18, insulating protective layer 50 is formed on first front electrode 31, first resistive element 20, intermediate electrode 26, second resistive element 23, and second front electrode 41. Specifically, insulating protective layer 50 is formed by printing a paste containing an insulating resin such as an epoxy resin onto first front electrode 31, first resistive element 20, intermediate electrode 26, second resistive element 23, and second front electrode 41 and curing the paste. First electroconductive resin layer 51 and second electroconductive resin layer 52 are then formed. Specifically, first electroconductive resin layer 51 is formed by printing a paste containing the binder resin and electroconductive particles on insulating protective layer 50 and first front electrode 31 and curing the paste. Second electroconductive resin layer 52 is formed by printing a paste containing the binder resin and electroconductive particles on insulating protective layer 50 and second front electrode 41 and curing the paste.

Referring to FIGS. 12, 13, and 19, first electrode 30 and second electrode 40 are formed.

Specifically, referring to FIG. 19, first side surface electrode 33 and second side surface electrode 43 are formed. First side surface electrode 33 is formed on first side surface 13 of insulating substrate 10, first front electrode 31, and first back electrode 32, for example, by physical vapor deposition (PVD) such as sputtering. First side surface electrode 33 is in contact with first front electrode 31 and first back electrode 32 to electrically conduct to first front electrode 31 and first back electrode 32. Second side surface electrode 43 is formed on second side surface 14 of insulating substrate 10, second front electrode 41, and second back electrode 42, for example, by physical vapor deposition (PVD) such as sputtering. Second side surface electrode 43 is in contact with second front electrode 41 and second back electrode 42 to electrically conduct to second front electrode 41 and second back electrode 42.

Referring to FIGS. 12 and 13, first metallic plated layer 34 and second metallic plated layer 44 are formed. First metallic plated layer 34 includes, for example, first inner plated layer 35, first intermediate plated layer 36, and first outer plated layer 37. Second metallic plated layer 44 includes, for example, second inner plated layer 45, second intermediate plated layer 46, and second outer plated layer 47.

Specifically, first inner plated layer 35 is formed on first front electrode 31, first back electrode 32, first side surface electrode 33, and first electroconductive resin layer 51. Second inner plated layer 45 is formed on second front electrode 41, second back electrode 42, second side surface electrode 43, and second electroconductive resin layer 52. First inner plated layer 35 and second inner plated layer 45 are each, for example, the copper plated layer. First intermediate plated layer 36 is then formed on first inner plated layer 35. Second intermediate plated layer 46 is formed on second inner plated layer 45. First intermediate plated layer 36 and second intermediate plated layer 46 are each, for example, the nickel plated layer. First outer plated layer 37 is then formed on first intermediate plated layer 36. Second outer plated layer 47 is formed on second intermediate plated layer 46. First outer plated layer 37 and second outer plated layer 47 are each, for example, the tin plated layer. Chip resistor 1 is thus obtained.

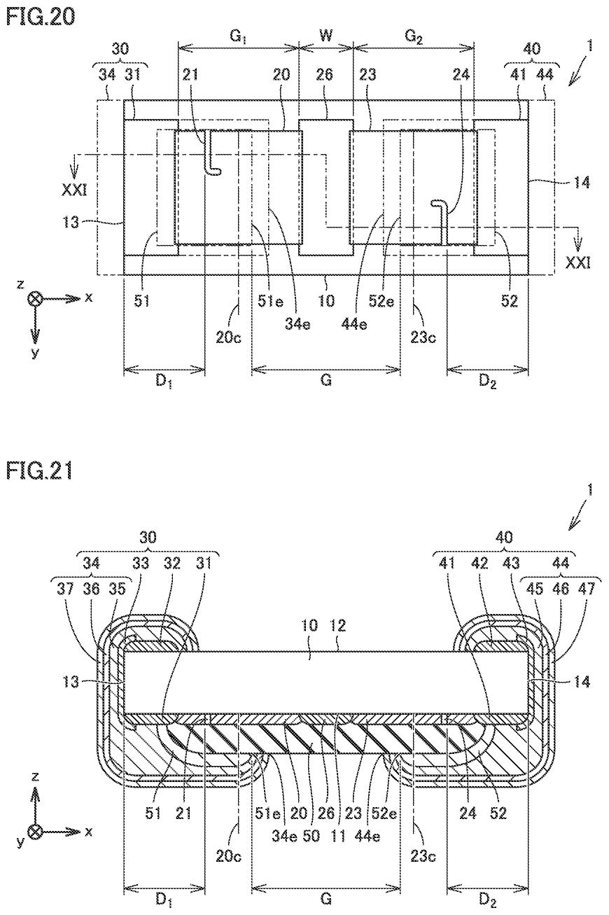

Referring to FIGS. 20 and 21, in a first modification of the present embodiment, in the plan view of first main surface 11 of insulating substrate 10, first electroconductive resin layer 51 may have end 51e closer to second front electrode 41 and second side surface 14 than first centerline 20c of first resistive element 20 in the first direction (x direction). In the plan view of first main surface 11 of insulating substrate 10, first electroconductive resin layer 51 may cover at least 50% of the area of first resistive element 20, at least 60% of the area of first resistive element 20, at least 70% of the area of first resistive element 20, at least 80% of the area of first resistive element 20, or at least 90% of the area of first resistive element 20.

In the plan view of first main surface 11 of insulating substrate 10, second electroconductive resin layer 52 may have end 52e closer to first front electrode 31 and first side surface 13 than second centerline 23c of second resistive element 23 in the first direction (x direction). In the plan view of first main surface 11 of insulating substrate 10, second electroconductive resin layer 52 may cover at least 50% of the area of second resistive element 23, at least 60% of the area of second resistive element 23, at least 70% of the area of second resistive element 23, at least 80% of the area of second resistive element 23, or at least 90% of the area of second resistive element 23.

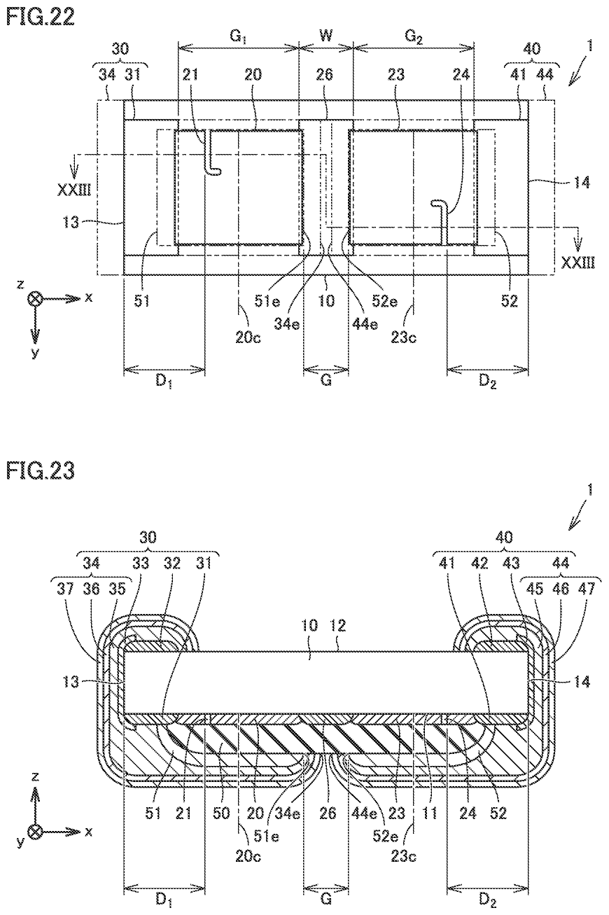

Referring to FIGS. 22 and 23, in a second modification of the present embodiment, in the plan view of first main surface 11 of insulating substrate 10, first electroconductive resin layer 51 may cover the entirety of first resistive element 20. In the plan view of first main surface 11 of insulating substrate 10, second electroconductive resin layer 52 may cover the entirety of second resistive element 23.

Functions of chip resistor 1 in the present embodiment will be described in comparison to a chip resistor in a third comparative example.

As a current flows through the chip resistor, the resistive element generates heat. In the chip resistor in the third comparative example, a single resistive element is provided at the center of insulating substrate 10 in the longitudinal direction (first direction (x direction)) of insulating substrate 10 and the entire resistive element is covered with an insulating protective film. The center of insulating substrate 10 is most separated from first side surface 13 and second side surface 14. While the chip resistor in the third comparative example is used, a temperature at the center of the chip resistor in the third comparative example significantly increases. The short time overload (STOL) characteristics of the chip resistor in the third comparative example are insufficient.

In contrast, chip resistor 1 in the present embodiment includes first resistive element 20 and second resistive element 23. First resistive element 20 is arranged closer to first side surface 13 of insulating substrate 10 than the single resistive element in the third comparative example, and second resistive element 23 is arranged closer to second side surface 14 of insulating substrate 10 than the single resistive element in the third comparative example. Therefore, heat generated in first resistive element 20 and second resistive element 23 while chip resistor 1 is used can more quickly be radiated to the outside of chip resistor 1 (for example, wiring board 60 (see FIG. 14) or an ambient environment around chip resistor 1 such as ambient air around chip resistor 1). Thus, increase in temperature at the center of chip resistor 1 while chip resistor 1 is used can be suppressed. The short time overload (STOL) characteristics of chip resistor 1 can be improved.

Chip resistor 1 in the present embodiment includes first electroconductive resin layer 51 and second electroconductive resin layer 52. First electroconductive resin layer 51 is provided on first front electrode 31, covers at least a part of first resistive element 20 in the plan view of first main surface 11 of insulating substrate 10, and is higher in thermal conductivity than insulating protective layer 50. Second electroconductive resin layer 52 is provided on second front electrode 41, covers at least a part of second resistive element 23 in the plan view of first main surface 11 of insulating substrate 10, and is higher in thermal conductivity than insulating protective layer 50. Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature at the center of chip resistor 1 while chip resistor 1 is used can thus be suppressed. The short time overload (STOL) characteristics of chip resistor 1 can be improved.

Effects of chip resistor 1 in the present embodiment will be described.

Chip resistor 1 in the present embodiment includes insulating substrate 10, first electrode 30, second electrode 40, first resistive element 20, second resistive element 23, intermediate electrode 26, insulating protective layer 50, first electroconductive resin layer 51, and second electroconductive resin layer 52. Insulating substrate 10 is provided with first main surface 11, first side surface 13, and second side surface 14 opposite to first side surface 13. First side surface 13 and second side surface 14 are each connected to first main surface 11. In the plan view of first main surface 11, first electrode 30 is provided closer to first side surface 13 than second electrode 40. First electrode 30 includes first front electrode 31 provided on first main surface 11. Second electrode 40 is separated from first electrode 30 and provided closer to second side surface 14 than first electrode 30 in the plan view of first main surface 11. Second electrode 40 includes second front electrode 41 provided on first main surface 11, second front electrode 41 being separated from first front electrode 31. First resistive element 20 is provided on first main surface 11 and in contact with first front electrode 31 and intermediate electrode 26. Second resistive element 23 is provided on first main surface 11, separated from first resistive element 20, and in contact with second front electrode 41 and intermediate electrode 26. Intermediate electrode 26 is provided on first main surface 11 and arranged between first resistive element 20 and second resistive element 23. Insulating protective layer 50 is provided on first resistive element 20, second resistive element 23, and intermediate electrode 26. Insulating protective layer 50 electrically isolates first electrode 30 and second electrode 40 from each other and electrically isolates first electroconductive resin layer 51 and second electroconductive resin layer 52 from each other. First electroconductive resin layer 51 is higher in thermal conductivity than insulating protective layer 50. First electroconductive resin layer 51 is provided on first front electrode 31 and insulating protective layer 50 and covers at least a part of first resistive element 20 in the plan view of first main surface 11 of insulating substrate 10. Second electroconductive resin layer 52 is separated from first electroconductive resin layer 51 and higher in thermal conductivity than insulating protective layer 50. Second electroconductive resin layer 52 is provided on second front electrode 41 and insulating protective layer 50 and covers at least a part of second resistive element 23 in the plan view of first main surface 11 of insulating substrate 10.

First resistive element 20 is arranged closer to first side surface 13 of insulating substrate 10 and second resistive element 23 is arranged closer to second side surface 14 of insulating substrate 10. In addition, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature at the center of chip resistor 1 while chip resistor 1 is used can thus be suppressed. The short time overload (STOL) characteristics of chip resistor 1 can be improved.

In chip resistor 1 in the present embodiment, in the plan view of first main surface 11 of insulating substrate 10, first electroconductive resin layer 51 covers at least 20% of the area of first resistive element 20 and second electroconductive resin layer 52 covers at least 20% of the area of second resistive element 23.

Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, first resistive element 20 is provided with first trimming groove 21. Second resistive element 23 is provided with second trimming groove 24. In the plan view of first main surface 11 of insulating substrate 10, first electroconductive resin layer 51 covers at least a part of first trimming groove 21 and second electroconductive resin layer 52 covers at least a part of second trimming groove 24.

Provision of first trimming groove 21 in first resistive element 20 and provision of second trimming groove 24 in second resistive element 23 allow accurate determination of the resistance value of chip resistor 1. As a current flows through chip resistor 1, a temperature of the portion of first resistive element 20 around first trimming groove 21 is highest in first resistive element 20 and a temperature of the portion of second resistive element 23 around second trimming groove 24 is highest in second resistive element 23. In chip resistor 1, in the plan view of first main surface 11 of insulating substrate 10, first electroconductive resin layer 51 covers at least a part of first trimming groove 21 and second electroconductive resin layer 52 covers at least a part of second trimming groove 24. Therefore, first electroconductive resin layer 51 and second electroconductive resin layer 52 can more quickly radiate to the outside of chip resistor 1, heat generated in the portion of first resistive element 20 around first trimming groove 21 and the portion of second resistive element 23 around second trimming groove 24 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, in the plan view of first main surface 11 of insulating substrate 10, first electroconductive resin layer 51 covers at least 50% of the entire length of first trimming groove 21 and second electroconductive resin layer 52 covers at least 50% of the entire length of second trimming groove 24.

Therefore, first electroconductive resin layer 51 and second electroconductive resin layer 52 can more quickly radiate to the outside of chip resistor 1, heat generated in the portion of first resistive element 20 around first trimming groove 21 and the portion of second resistive element 23 around second trimming groove 24 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, in the plan view of first main surface 11 of insulating substrate 10, first electroconductive resin layer 51 covers the entirety of first trimming groove 21 and second electroconductive resin layer 52 covers the entirety of second trimming groove 24.

Therefore, first electroconductive resin layer 51 and second electroconductive resin layer 52 can more quickly radiate to the outside of chip resistor 1, heat generated in the portion of first resistive element 20 around first trimming groove 21 and the portion of second resistive element 23 around second trimming groove 24 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, in the plan view of first main surface 11 of insulating substrate 10, first trimming groove 21 is provided close to first front electrode 31 and first side surface 13 with respect to first centerline 20c of first resistive element 20 in the first direction (x direction) and second trimming groove 24 is provided close to second front electrode 41 and second side surface 14 with respect to second centerline 23c of second resistive element 23 in the first direction (x direction).

As a current flows through chip resistor 1, the temperature of the portion of first resistive element 20 around first trimming groove 21 is highest in first resistive element 20 and the temperature of the portion of second resistive element 23 around second trimming groove 24 is highest in second resistive element 23. In chip resistor 1, first trimming groove 21 is arranged closer to first side surface 13 of insulating substrate 10 and second trimming groove 24 is arranged closer to second side surface 14 of insulating substrate 10. Therefore, heat generated in the portion of first resistive element 20 around first trimming groove 21 and the portion of second resistive element 23 around second trimming groove 24 can more quickly be radiated to the outside of chip resistor 1. Increase in temperature of chip resistor 1 while chip resistor 1 is used can be suppressed. The short time overload (STOL) characteristics of chip resistor 1 can be improved.

In chip resistor 1 in the present embodiment, in the plan view of first main surface 11 of insulating substrate 10, first distance D₁ between first trimming groove 21 and first side surface 13 is 400 μm or shorter and second distance D₂ between second trimming groove 24 and second side surface 14 is 400 μm or shorter.

Therefore, first trimming groove 21 is arranged closer to first side surface 13 of insulating substrate 10 and second trimming groove 24 is arranged closer to second side surface 14 of insulating substrate 10. Heat generated in the portion of first resistive element 20 around first trimming groove 21 and the portion of second resistive element 23 around second trimming groove 24 can more quickly be radiated to the outside of chip resistor 1. Increase in temperature of chip resistor 1 while chip resistor 1 is used can be suppressed. The short time overload (STOL) characteristics of chip resistor 1 can be improved.

In chip resistor 1 in the present embodiment, first electrode 30 further includes first metallic plated layer 34. Second electrode 40 further includes second metallic plated layer 44. First metallic plated layer 34 is provided on first front electrode 31 and first electroconductive resin layer 51 and higher in thermal conductivity than insulating protective layer 50. Second metallic plated layer 44 is provided on second front electrode 41 and second electroconductive resin layer 52 and higher in thermal conductivity than insulating protective layer 50. In the plan view of first main surface 11 of insulating substrate 10, first metallic plated layer 34 has the first end (end 34e) closer to second front electrode 41 than first centerline 20c of first resistive element 20 in the first direction (x direction) and second metallic plated layer 44 has the second end (end 44e) closer to first front electrode 31 than second centerline 23c of second resistive element 23 in the first direction (x direction). In the plan view of first main surface 11 of insulating substrate 10, the first end (end 34e) of first metallic plated layer 34 is the proximal end of first metallic plated layer 34 to intermediate electrode 26. In the plan view of first main surface 11 of insulating substrate 10, the second end (end 44e) of second metallic plated layer 44 is the proximal end of second metallic plated layer 44 to intermediate electrode 26.

Therefore, first metallic plated layer 34 and second metallic plated layer 44 can more quickly radiate to the outside of chip resistor 1, heat generated in first resistive element 20 and second resistive element 23 while chip resistor 1 is used. Increase in temperature at the center of chip resistor 1 while chip resistor 1 is used can thus be suppressed. The short time overload (STOL) characteristics of chip resistor 1 can be improved.

In chip resistor 1 in the present embodiment, insulating substrate 10 is provided with second main surface 12 opposite to first main surface 11. First electrode 30 includes first back electrode 32 provided on second main surface 12. Second electrode 40 includes second back electrode 42 provided on second main surface 12. First metallic plated layer 34 is in contact with first front electrode 31 and first back electrode 32. Second metallic plated layer 44 is in contact with second front electrode 41 and second back electrode 42.

First back electrode 32 can more quickly radiate heat generated in first resistive element 20 to the outside of chip resistor 1. Second back electrode 42 can more quickly radiate heat generated in second resistive element 23 to the outside of chip resistor 1. Increase in temperature of chip resistor 1 while chip resistor 1 is used can be suppressed. The short time overload (STOL) characteristics of chip resistor 1 can be improved.

In chip resistor 1 in the present embodiment, first metallic plated layer 34 includes the first copper plated layer in contact with first front electrode 31. Second metallic plated layer 44 includes the second copper plated layer in contact with second front electrode 41.

Copper has a thermal conductivity of 398 W/(m·K), and the copper plated layer has the very high thermal conductivity. Therefore, first metallic plated layer 34 can more quickly radiate heat generated in first resistive element 20 to the outside of chip resistor 1. Second metallic plated layer 44 can more quickly radiate heat generated in second resistive element 23 to the outside of chip resistor 1. Increase in temperature of chip resistor 1 while chip resistor 1 is used can be suppressed. The short time overload (STOL) characteristics of chip resistor 1 can be improved.

In chip resistor 1 in the present embodiment, in the plan view of first main surface 11 of insulating substrate 10, first electroconductive resin layer 51 has the third end (end 51e) closer to second front electrode 41 than first centerline 20c of first resistive element 20 in the first direction (x direction) and second electroconductive resin layer 52 has the fourth end (end 52e) closer to first front electrode 31 than second centerline 23c of second resistive element 23 in the first direction (x direction). In the plan view of first main surface 11 of insulating substrate 10, the third end (end 51e) of first electroconductive resin layer 51 is the distal end of first electroconductive resin layer 51 from first side surface 13. In the plan view of first main surface 11 of insulating substrate 10, the fourth end (end 52e) of second electroconductive resin layer 52 is the distal end of second electroconductive resin layer 52 from second side surface 14.

Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature at the center of chip resistor 1 while chip resistor 1 is used can be suppressed. The short time overload (STOL) characteristics of chip resistor 1 can be improved.

In chip resistor 1 in the present embodiment, in the plan view of first main surface 11 of insulating substrate 10, first electroconductive resin layer 51 covers the entirety of first resistive element 20 and second electroconductive resin layer 52 covers the entirety of second resistive element 23.

Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, the interval between first electroconductive resin layer 51 and second electroconductive resin layer 52 is 300 μm or larger.

Therefore, contact between first electroconductive resin layer 51 and second electroconductive resin layer 52 and resultant electrical short-circuiting between first electroconductive resin layer 51 and second electroconductive resin layer 52 in formation of first electroconductive resin layer 51 and second electroconductive resin layer 52 can more reliably be prevented.

In chip resistor 1 in the present embodiment, first electroconductive resin layer 51 and second electroconductive resin layer 52 each include a binder resin and electroconductive particles added to the binder resin.

Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature of chip resistor 1 while chip resistor 1 is used can be suppressed. The short time overload (STOL) characteristics of chip resistor 1 can be improved.

In chip resistor 1 in the present embodiment, the binder resin is formed of the epoxy resin, the phenol resin, or combination thereof. The electroconductive particles are carbon particles, metallic particles, or combination thereof.

Therefore, first electroconductive resin layer 51 and second electroconductive resin layer 52 can more quickly radiate to the outside of chip resistor 1, heat generated in first resistive element 20 and second resistive element 23 while chip resistor 1 is used. Increase in temperature of chip resistor 1 while chip resistor 1 is used can be suppressed. The short time overload (STOL) characteristics of chip resistor 1 can be improved.

### Additional Aspect

### Additional Aspect 1

A chip resistor including:
an insulating substrate provided with a first main surface, a first side surface, and a second side surface opposite to the first side surface;
a first electrode;
a second electrode separated from the first electrode, the second electrode being provided closer to the second side surface than the first electrode in a plan view of the first main surface;
a first resistive element provided on the first main surface;
a second resistive element provided on the first main surface, the second resistive element being separated from the first resistive element;
an intermediate electrode provided on the first main surface and arranged between the first resistive element and the second resistive element;
an insulating protective layer provided on the first resistive element, the second resistive element, and the intermediate electrode;
a first electroconductive resin layer higher in thermal conductivity than the insulating protective layer; and
a second electroconductive resin layer being separated from the first electroconductive resin layer, the second electroconductive resin layer being higher in thermal conductivity than the insulating protective layer, wherein
the first side surface and the second side surface are each connected to the first main surface,
in the plan view of the first main surface, the first electrode is provided closer to the first side surface than the second electrode,
the first electrode includes a first front electrode provided on the first main surface,
the second electrode includes a second front electrode provided on the first main surface, the second front electrode being separated from the first front electrode,
the first resistive element is in contact with the first front electrode and the intermediate electrode,
the second resistive element is in contact with the second front electrode and the intermediate electrode,
the first electroconductive resin layer is provided on the first front electrode and the insulating protective layer and covers at least a part of the first resistive element in the plan view of the first main surface,
the second electroconductive resin layer is provided on the second front electrode and the insulating protective layer and covers at least a part of the second resistive element in the plan view of the first main surface, and
the insulating protective layer electrically isolates the first electrode and the second electrode from each other and electrically isolates the first electroconductive resin layer and the second electroconductive resin layer from each other.

### Additional Aspect 2

The chip resistor according to Additional Aspect 1, wherein
in the plan view of the first main surface, the first electroconductive resin layer covers at least 20% of an area of the first resistive element and the second electroconductive resin layer covers at least 20% of the area of the second resistive element.

### Additional Aspect 3

The chip resistor according to Additional Aspect 1 or 2, wherein
the first resistive element is provided with a first trimming groove,
the second resistive element is provided with a second trimming groove, and
in the plan view of the first main surface, the first electroconductive resin layer covers at least a part of the first trimming groove and the second electroconductive resin layer covers at least a part of the second trimming groove.

### Additional Aspect 4

The chip resistor according to Additional Aspect 3, wherein
in the plan view of the first main surface, the first electroconductive resin layer covers at least 50% of an entire length of the first trimming groove and the second electroconductive resin layer covers at least 50% of an entire length of the second trimming groove.

### Additional Aspect 5

The chip resistor according to Additional Aspect 3 or 4, wherein
in the plan view of the first main surface, the first electroconductive resin layer covers the entirety of the first trimming groove and the second electroconductive resin layer covers the entirety of the second trimming groove.

### Additional Aspect 6

The chip resistor according to any one of Additional Aspects 3 to 5, wherein
in the plan view of the first main surface, the first trimming groove is provided close to the first front electrode and the first side surface with respect to a first centerline of the first resistive element in a direction in which the first resistive element and the second resistive element are separated from each other, and the second trimming groove is provided close to the second front electrode and the second side surface with respect to a second centerline of the second resistive element in the direction.

### Additional Aspect 7

The chip resistor according to any one of Additional Aspects 3 to 6, wherein
in the plan view of the first main surface, a first distance between the first trimming groove and the first side surface is 400 μm or shorter and a second distance between the second trimming groove and the second side surface is 400 μm or shorter.

### Additional Aspect 8

The chip resistor according to any one of Additional Aspects 1 to 5, wherein
the first electrode further includes a first metallic plated layer,
the second electrode further includes a second metallic plated layer,
the first metallic plated layer is provided on the first front electrode and the first electroconductive resin layer and higher in thermal conductivity than the insulating protective layer,
the second metallic plated layer is provided on the second front electrode and the second electroconductive resin layer and higher in thermal conductivity than the insulating protective layer,
in the plan view of the first main surface, the first metallic plated layer has a first end closer to the second front electrode than a first centerline of the first resistive element in a direction in which the first resistive element and the second resistive element are separated from each other and the second metallic plated layer has a second end closer to the first front electrode than a second centerline of the second resistive element in the direction,
the first end of the first metallic plated layer is a proximal end of the first metallic plated layer to the intermediate electrode in the plan view of the first main surface, and
the second end of the second metallic plated layer is a proximal end of the second metallic plated layer to the intermediate electrode in the plan view of the first main surface.

### Additional Aspect 9

The chip resistor according to Additional Aspect 8, wherein
the insulating substrate is provided with a second main surface opposite to the first main surface,
the first electrode includes a first back electrode provided on the second main surface,
the second electrode includes a second back electrode provided on the second main surface,
the first metallic plated layer is in contact with the first front electrode and the first back electrode, and
the second metallic plated layer is in contact with the second front electrode and the second back electrode.

### Additional Aspect 10

The chip resistor according to Additional Aspect 8 or 9, wherein
the first metallic plated layer includes a first copper plated layer in contact with the first front electrode, and
the second metallic plated layer includes a second copper plated layer in contact with the second front electrode.

### Additional Aspect 11

The chip resistor according to any one of Additional Aspects 1 to 5, wherein
in the plan view of the first main surface, the first electroconductive resin layer has a third end closer to the second front electrode than a first centerline of the first resistive element in a direction in which the first resistive element and the second resistive element are separated from each other and the second electroconductive resin layer has a fourth end closer to the first front electrode than a second centerline of the second resistive element in the direction,
the third end of the first electroconductive resin layer is a distal end of the first electroconductive resin layer from the first side surface in the plan view of the first main surface, and
the fourth end of the second electroconductive resin layer is a distal end of the second electroconductive resin layer from the second side surface in the plan view of the first main surface.

### Additional Aspect 12

The chip resistor according to any one of Additional Aspects 1 to 11, wherein
in the plan view of the first main surface, the first electroconductive resin layer covers the entirety of the first resistive element and the second electroconductive resin layer covers the entirety of the second resistive element.

### Additional Aspect 13

The chip resistor according to any one of Additional Aspects 1 to 12, wherein
an interval between the first electroconductive resin layer and the second electroconductive resin layer is 300 μm or larger.

### Additional Aspect 14

The chip resistor according to any one of Additional Aspects 1 to 13, wherein
the first electroconductive resin layer and the second electroconductive resin layer each contain a binder resin and electroconductive particles added to the binder resin.

### Additional Aspect 15

The chip resistor according to Additional Aspect 14, wherein
the binder resin is formed of an epoxy resin, a phenol resin, or combination of the epoxy resin and the phenol resin, and
the electroconductive particles are carbon particles, metallic particles, or combination of the carbon particles and the metallic particles.

It should be understood that the first embodiment and the second embodiment as well as the modifications thereof disclosed herein are illustrative and non-restrictive in every respect. The scope of the present disclosure is defined by the terms of the claims rather than the description above and is intended to include any modifications within the scope and meaning equivalent to the terms of the claims.

### REFERENCE SIGNS LIST

1 chip resistor; 10 insulating substrate; 11 first main surface; 12 second main surface; 13 first side surface; 14 second side surface; 20 first resistive element; 20a outer periphery; 20c first centerline; 21 first trimming groove; 21a, 21b trimming groove portion; 22a, 22b end; 23 second resistive element; 23a outer periphery; 23c second centerline; 24 second trimming groove; 25a, 25b end; 26 intermediate electrode; 30 first electrode; 31 first front electrode; 32 first back electrode; 33 first side surface electrode; 34 first metallic plated layer; 34e end; 35 first inner plated layer; 36 first intermediate plated layer; 37 first outer plated layer; 40 second electrode; 41 second front electrode; 42 second back electrode; 43 second side surface electrode; 44 second metallic plated layer; 44e end; 45 second inner plated layer; 46 second intermediate plated layer; 47 second outer plated layer; 50 insulating protective layer; 51 first electroconductive resin layer; 51e end; 52 second electroconductive resin layer; 52e end; 60 wiring board; 61 insulating substrate; 62, 63 electrical wire; 64, 65 conductive bonding member

1. A chip resistor comprising:
an insulating substrate provided with a first main surface, a first side surface, and a second side surface opposite to the first side surface;
a first electrode;
a second electrode separated from the first electrode, the second electrode being provided closer to the second side surface than the first electrode in a plan view of the first main surface;
a first resistive element provided on the first main surface;
a second resistive element provided on the first main surface, the second resistive element being separated from the first resistive element; and
an intermediate electrode provided on the first main surface and arranged between the first resistive element and the second resistive element, wherein
the first side surface and the second side surface are each connected to the first main surface,
in the plan view of the first main surface, the first electrode is provided closer to the first side surface than the second electrode,
the first electrode includes a first front electrode provided on the first main surface,
the second electrode includes a second front electrode provided on the first main surface, the second front electrode being separated from the first front electrode,
the first resistive element is in contact with the first front electrode and the intermediate electrode,
the second resistive element is in contact with the second front electrode and the intermediate electrode,
a first length of the first resistive element in a first direction in which the first resistive element and the second resistive element are separated from each other is longer than a second length of the second resistive element in the first direction,
the first resistive element is provided with a first trimming groove, and
the second resistive element is provided with a second trimming groove.

2. The chip resistor according to claim 1, wherein
the first length is at least 1.2 time as long as the second length.

3. The chip resistor according to claim 1, wherein
the first length is at least 1.5 time as long as the second length.

4. The chip resistor according to claim 1, wherein
the first trimming groove includes a first trimming groove portion and a second trimming groove portion connected to the first trimming groove portion,
in the plan view of the first main surface, a longitudinal direction of the first trimming groove portion extends along a second direction perpendicular to the first direction,
in the plan view of the first main surface, a longitudinal direction of the second trimming groove portion extends along the first direction, and
in the plan view of the first main surface, the longitudinal direction of the second trimming groove extends along the second direction.

5. The chip resistor according to claim 1, wherein
a first ratio of a trimming groove absent portion in the first resistive element in a second direction perpendicular to the first direction in the plan view of the first main surface is substantially equal to a second ratio of a trimming groove absent portion in the second resistive element in the second direction.

6. The chip resistor according to claim 4, wherein
the first trimming groove portion is provided on a first centerline of the first resistive element in the first direction or close to the first front electrode with respect to the first centerline, and
the second trimming groove portion extends from the first trimming groove portion toward the first front electrode.

7. The chip resistor according to claim 1, wherein
the first trimming groove is provided close to the first front electrode and the first side surface with respect to a first centerline of the first resistive element in the first direction, and
the second trimming groove is provided close to the second front electrode and the second side surface with respect to a second centerline of the second resistive element in the first direction.

8. The chip resistor according to claim 6, wherein
a first distance between the first trimming groove and the first side surface is 400 μm or shorter, and
a second distance between the second trimming groove and the second side surface is 400 μm or shorter.

9. The chip resistor according to claim 1, further comprising:
an insulating protective layer provided on the first resistive element, the second resistive element, and the intermediate electrode;
a first electroconductive resin layer higher in thermal conductivity than the insulating protective layer; and
a second electroconductive resin layer being separated from the first electroconductive resin layer and higher in thermal conductivity than the insulating protective layer, wherein
the first electroconductive resin layer is provided on the first front electrode and the insulating protective layer and covers at least a part of the first resistive element in the plan view of the first main surface,
the second electroconductive resin layer is provided on the second front electrode and the insulating protective layer and covers at least a part of the second resistive element in the plan view of the first main surface,
the insulating protective layer electrically isolates the first electrode and the second electrode from each other and electrically isolates the first electroconductive resin layer and the second electroconductive resin layer from each other, and
in the plan view of the first main surface, the first electroconductive resin layer covers at least a part of the first trimming groove and the second electroconductive resin layer covers at least a part of the second trimming groove.

10. The chip resistor according to claim 9, wherein
in the plan view of the first main surface, the first electroconductive resin layer covers at least 20% of an area of the first resistive element and the second electroconductive resin layer covers at least 20% of an area of the second resistive element.

11. The chip resistor according to claim 9, wherein
in the plan view of the first main surface, the first electroconductive resin layer covers at least 50% of an entire length of the first trimming groove and the second electroconductive resin layer covers at least 50% of an entire length of the second trimming groove.

12. The chip resistor according to claim 9, wherein
in the plan view of the first main surface, the first electroconductive resin layer covers entirety of the first trimming groove and the second electroconductive resin layer covers entirety of the second trimming groove.

13. The chip resistor according to claim 9, wherein
an interval between the first electroconductive resin layer and the second electroconductive resin layer is 300 μm or larger.

14. The chip resistor according to claim 9, wherein
in the plan view of the first main surface, the first electroconductive resin layer has a first end closer to the second front electrode than a first centerline of the first resistive element in the first direction and the second electroconductive resin layer has a second end closer to the first front electrode than a second centerline of the second resistive element in the first direction,
the first end of the first electroconductive resin layer is a distal end of the first electroconductive resin layer from the first side surface in the plan view of the first main surface, and
the second end of the second electroconductive resin layer is a distal end of the second electroconductive resin layer from the second side surface in the plan view of the first main surface.

15. The chip resistor according to claim 9, wherein
the first electrode further includes a first metallic plated layer,
the second electrode further includes a second metallic plated layer,
the first metallic plated layer is provided on the first front electrode and the first electroconductive resin layer and higher in thermal conductivity than the insulating protective layer,
the second metallic plated layer is provided on the second front electrode and the second electroconductive resin layer and higher in thermal conductivity than the insulating protective layer,
in the plan view of the first main surface, the first metallic plated layer has a third end closer to the second front electrode than a first centerline of the first resistive element in the first direction and the second metallic plated layer has a fourth end closer to the first front electrode than a second centerline of the second resistive element in the first direction,
the third end of the first metallic plated layer is a proximal end of the first metallic plated layer to the intermediate electrode in the plan view of the first main surface, and
the fourth end of the second metallic plated layer is a proximal end of the second metallic plated layer to the intermediate electrode in the plan view of the first main surface.

16. The chip resistor according to claim 15, wherein
the insulating substrate is provided with a second main surface opposite to the first main surface,
the first electrode includes a first back electrode provided on the second main surface,
the second electrode includes a second back electrode provided on the second main surface,
the first metallic plated layer is in contact with the first front electrode and the first back electrode, and
the second metallic plated layer is in contact with the second front electrode and the second back electrode.

17. The chip resistor according to claim 15, wherein
the first metallic plated layer includes a first copper plated layer in contact with the first front electrode, and
the second metallic plated layer includes a second copper plated layer in contact with the second front electrode.

18. The chip resistor according to claim 9, wherein
the first electroconductive resin layer and the second electroconductive resin layer each contain a binder resin and electroconductive particles added to the binder resin.

19. The chip resistor according to claim 18, wherein
the binder resin is formed of an epoxy resin, a phenol resin, or combination of the epoxy resin and the phenol resin, and
the electroconductive particles are carbon particles, metallic particles, or combination of the carbon particles and the metallic particles.
